(19) United States
(12) Patent Application Publication
(10) Pub. No.: US 2017/0109767 A1
(43) Pub. Date: Apr. 20, 2017

(54) REAL-TIME DYNAMIC PRICING SYSTEM

(71) Applicants: Arie Shpanya, San Francisco, CA (US); David R. Brecher, San Francisco, CA (US)

(72) Inventors: Arie Shpanya, San Francisco, CA (US); David R. Brecher, San Francisco, CA (US)

(21) Appl. No.: 15/318,251

(22) PCT Filed: Jun. 12, 2015
(86) PCT No.: PCT/US15/35699

§ 371 Date: Dec. 12, 2016

Related U.S. Application Data
(60) Provisional application No. 62/011,366, filed on Jun. 12, 2014.

(51) Int. Cl. G06Q 30/02

(52) U.S. Cl. CPC G06Q 30/0206; G06Q 30/0283

(57) ABSTRACT

A real-time dynamic pricing system and method is provided, which includes a user interface, scraping and analytics components, and a batch processing server. Using the pricing system, a seller defines a product that is sold via the seller's webstore and another webstore that competes with it. The pricing system then configures a scraper based on the competing webstore's site layout. The scraper, executing in the cloud, determines whether the product is offered for sale through the competing webstore by scraping data from one of its webpages. If the scraper finds an exact product match, the scraper stores the data attributes in a data store accessible to the dynamic pricing system, and creates a price data point from the data attributes. Once the pricing system has compiled sufficient pricing data, the pricing system estimates an optimal price for the product by applying a user-specified pricing rule to the pricing data.

### CROSS-REFERENCE TO RELATED APPLICATIONS

This non-provisional application claims the benefit of U.S. Provisional Application No. 62/011,366 under 35 U.S.C. §119(e).

### STATEMENT REGARDING FEDERALLY SPONSORED RESEARCH OR DEVELOPMENT

Not Applicable PARTIES TO A JOINT RESEARCH AGREEMENT

Not Applicable

### REFERENCE TO SEQUENCE LISTING, TABLE, OR COMPUTER PROGRAM LISTING APPENDIX

Not Applicable

### STATEMENT REGARDING PRIOR DISCLOSURES BY THE INVENTOR OR A JOINT INVENTOR

Not Applicable

### BACKGROUND

1. Field of the Disclosure

This invention relates in general to the field of econometrics, and more particularly to a method, apparatus and system for frequently and rapidly determining optimum prices for a set of products, where the optimum prices are determined to maximize a merchandising figure of merit such as sales volume, revenue, or profit margin.

2. Background

Today, sellers conduct market research by browsing through different websites in order to determine the optimal product price. Unfortunately, this type of background research is cumbersome and consumes copious amounts of time. Moreover, it is difficult for retailers to keep track of the large volume of detailed data in order to determine pricing.

Speed is important because pricing data and market data fluctuates so quickly. As competition in the marketplace grows, margins are squeezed and profits may depend on capturing subtle or rapid shifts in demand for particular products. Offering products for sale at prices that do not fully reflect current market conditions may lead to lower sales or lower profits in the aggregate.

Therefore, an accurate model of nearly instantaneous market demand is desired.

### BRIEF SUMMARY

It is apparent that a need exists for a more efficient method and system for pricing products. The present invention is directed toward providing such a technique. Thus, it is an object of the present invention to provide a method and system that maximizes the seller's desired objective (e.g., sales volume, revenue, profit margin, etc.). A specific object of the present invention is to help sellers stay current, immediately reacting and adapting to the ever-changing marketplace. A further object of the invention is to provide a technique that saves time for the seller in ascertaining the most effective product price. Still a further object is to provide a user-friendly platform for bringing market awareness, automation and analysis to the seller.

In accordance with one aspect of the present invention, a real-time dynamic pricing system is provided, which includes a user interface, scraping and analytics components, and a batch processing server. Using the pricing system, a seller defines a product that is sold via the seller's webstore and another webstore that competes with it. The pricing system then configures a scraper based on the competing webstore's site layout. The scraper, executing in the cloud, determines whether the product is offered for sale through the competing webstore by scraping data from one of its webpages. If the scraper finds an exact product match, the scraper stores the data attributes in a data store accessible to the dynamic pricing system, and creates a price data point from the data attributes. Once the pricing system has compiled sufficient pricing data, the pricing system estimates an optimal price for the product by applying a user-specified pricing rule to the pricing data.

Other embodiments may include a method for providing an embeddable script, which may be incorporated into a product page of the seller's web store that offers the product for sale. A pricing system performing the method may then receive a sale notification message from a remote system executing the embeddable script, which was triggered by a customer completing a purchase of the product from the seller's webstore. Data attributes associated with the product transaction are extracted from the sale notification message and used to create a sales data point, which is inserted into a sales data repository.

### BRIEF DESCRIPTION OF THE DRAWINGS

For a more complete understanding of the present invention and its advantages, reference is now made to the following description and the accompanying drawings, in which:

FIG. 1 illustrates a high level block diagram depicting an interaction of three process components of a system in accordance with an illustrative embodiment.

FIG. 2 illustrates a simplified flow diagram illustrating the overall pricing scheme in accordance with an illustrative embodiment.

FIG. 3 illustrates is a block diagram of a web infrastructure of a pricing system in accordance with an illustrative embodiment.

FIG. 4 illustrates a user interface for searching for and selecting competitors from a predefined database of competitors in accordance with an illustrative embodiment.

FIG. 5 illustrates a tool for assembling scrapers from one or more subcomponents in accordance with an illustrative embodiment.

FIG. 6 illustrates an exemplary user interface for purposes of resolving near matches in accordance with an illustrative embodiment.

FIG. 7 illustrates a subsystem for tracking sales data using a cloud-based web infrastructure in accordance with an illustrative embodiment.

FIG. 8 illustrates an example of a user interface for facilitating the selection of a pricing strategy in accordance with an illustrative embodiment

FIG. 9 illustrates a user interface that assists in the identification of one or more products for product grouping in accordance with an illustrative embodiment.

FIG. 10 illustrates an exemplary user interface for customizing a selected pricing rule in accordance with an illustrative embodiment.

FIG. 11 illustrates another user interface for reviewing and confirming selected settings associated with the pricing strategy in accordance with an illustrative embodiment.

FIG. 12 illustrates an exemplary user interface for configuring a pricing a strategy based on any competitor found on the web.

FIG. 13 illustrates a user interface for configuring a dynamic pricing rule based on Amazon-specific features.

FIG. 14 illustrates a user interface for configuring a dynamic pricing rule based on eBay-specific features.

FIG. 15 illustrates a user interface for configuring pricing strategies that depend on the time of day in accordance with an illustrative embodiment.

FIG. 16 illustrates a user interface for configuring a pricing strategy based on incoming traffic in accordance with an illustrative embodiment.

FIG. 17 illustrates a user interface for configuring a pricing rule based on conversion rate in accordance with an illustrative embodiment.

FIG. 18 illustrates a user interface for configuring a pricing rule based on sales velocity in accordance with an illustrative embodiment.

FIG. 19A shows a graph of demand as a function of price.

FIG. 19B shows a graph of profit as a function of price.

FIG. 19C shows an estimated demand function based on a series of sales data.

FIG. 19D illustrates the problem of low price dispersion.

FIG. 20 illustrates the platform the user can utilize to monitor the progress of sales of each different product in accordance with an illustrative embodiment.

FIG. 21 illustrates a configurable dashboard that presents a high-level summary of the seller's sales metrics in accordance with an illustrative embodiment.

FIG. 22 illustrates a user interface that provides a more detailed grid view of the seller's product catalogue

FIG. 23 illustrates a user interface from the WisePricer Analytics module in accordance with an illustrative embodiment.

FIG. 24 illustrates the Competitive Landscape user interface with a zoomable heatmap in accordance with an illustrative embodiment.

FIG. 25 illustrates user interface for monitoring whether a product price is below a minimum advertised price in accordance with an illustrative embodiment.

FIG. 26 illustrates another user interface for monitoring minimum advertised pricing violators in accordance with an illustrative embodiment.

FIG. 27 illustrates a user interface for monitoring MAP violators in accordance with an illustrative embodiment.

FIG. 28 illustrates a user interface for reviewing screen shot evidence of a MAP violation in accordance with an illustrative embodiment.

### DETAILED DESCRIPTION

In view of the foregoing, through one or more various aspects, embodiments and/or specific features or sub-components, the present disclosure is thus intended to bring out one or more of the advantages that will be evident from the description. The present disclosure makes reference to one or more specific embodiments by way of illustration and example. It is understood, therefore, that the terminology, examples, drawings and embodiments are illustrative and are not intended to limit the scope of the disclosure.

A retailer may price or re-price products dynamically in accordance with a number of variables that includes, but is not limited to competitor pricing, time of day, sales performance, traffic, or conversion rates. This allows retailers to capitalize on this data to optimize pricing for profit and revenue. Oftentimes, a retailer may engage a service provider to implement a dynamic pricing strategy. For example, a dynamic pricing engine will facilitate data capture, aggregation, analysis, and automation. Using a dynamic pricing algorithm based on captured data, prices will be optimized with reference to the data and the products may be automatically re-priced accordingly.

Using any of the information available publically and within a retail company, the system is able to calculate the optimal price for an item. The optimal price can be calculated based on a weighted algorithm of variables, or otherwise aggregating the respective attributes.

Different dynamic pricing strategies may include some or all of the following variables: competitor pricing, time of day, sales performance, traffic, and conversion rates. For instance, a strategy of a particular retailer or for a particular retail product or category may be to price within 1% of a specific competitor. A different retailer may base the strategy on conversion rates, where a product's price will drop until the desired conversion rate is achieved.

The dynamic pricing system may store or derive information, which reflects the captured variables and subsequent analysis. Any information the user chooses to share with the dynamic pricing system may be used as a variable to determine pricing.

### SYSTEM OVERVIEW

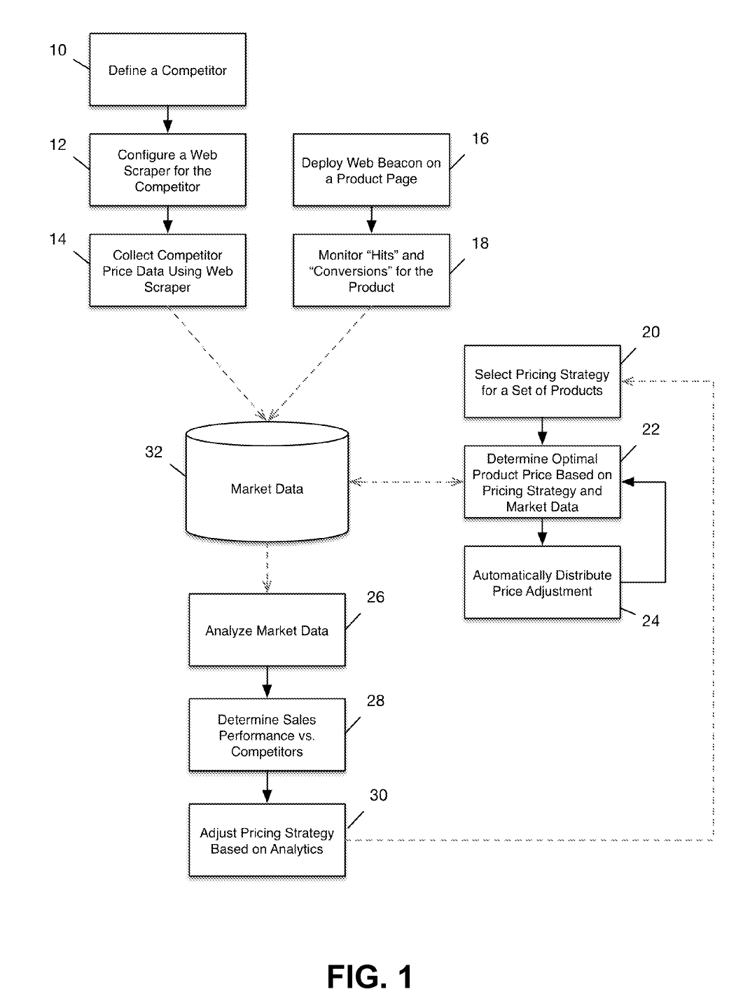

Embodiments of the present invention provide a system and method for enabling dynamic product pricing. The system includes a pricing and merchandising engine that monitors, analyzes, and implements price changes. The system is configured to implement three primary components to the dynamic pricing process: (1) data gathering; (2) price automation; and (3) market analytics. As an example, FIG. 1 depicts a high level system comprising a data gathering component, a pricing automation component, and an analytics component in accordance with an illustrative embodiment. The various components will be discussed briefly with respect to FIG. 1, but will be discussed in further detail.

The data gathering component is represented generally by a series of processes that are identified by reference numerals 10, 12, 14, 16, and 18. Process 10 defines a competitor. Process 12 configures a web scraper to gather specified data related to the competitor defined in process 10. Process 14 collects competitor data using the configured web scraper. The competitor data may include, for example, pricing data, internal sales velocity, number of hits or traffic per product page, conversion rate (sales of item per total traffic per page), and standard deviation for the product. An additional source of data collecting by the data gathering component includes data associated with a seller's webstore. Thus, process 16 deploys a web beacon on a seller's product page for capturing seller-related data, and process 18 monitors “hits” and “conversions” for items on the product page. Thus, competitor data may be captured through scraping of the competitor's webstore and a seller's sales data may be synced from a seller's existing ecommerce platform.

The pricing automation component is represented generally by reference numerals 20, 22, and 24. Process 20 selects a pricing strategy for a set of products. Process 22 determines an optimal product price based on pricing strategy and market data. And finally, process 24 automatically distributes price adjustments based on data generated from processes 20 and 22. Generally, the pricing automation component aggregates the monitored data from the data gathering component and performs analysis to determine optimal pricing for a retail product. The system may use this information to automatically tailor the re-pricing of an online retail item according to the set goals, which may be based on revenue, margin, or conversion targets. By automating dynamic re-pricing of products, the user improves the likelihood of increasing profits as pricing is adjusted to real-time changes in the market.

Auto-pricing is achieved in accordance with price suggestions offered by the pricing engine. The seller's catalog is re-priced in set intervals (for instance once a day) based on intelligent rules such as competition, margins, conversion rate, and more. The seller's catalog includes the various products offered by the seller. The sales catalog may include all of a seller's products or only a subset of the products.

The analytics component is represented generally by reference numerals 26, 28, and 30. Process 26 analyzes market data. Process 28 determines sales performance of a seller relative to competitors, and process 30 adjusts a pricing strategy based on analytics. Post-re-pricing analysis within the system shows the actual results of the pricing rule change in terms of sales, profit, and revenue impact to measure effectiveness of the dynamic pricing strategy.

In operation, data gathered from the data gathering component is fed into a data repository represented by market data 32. Market data 32 gathered by the data gathering component is sent to the pricing automation component for dynamically setting or resetting a price of a seller's products. Updated data is returned to market data 32, which is then sent to the analytics component for processing. Based on the result of the processing, feedback may be returned to the pricing automation component, and to process 20 in particular, for further price adjustments. The cycle may be repeated at any interval so that fresh data is constantly gathered and used for setting or resetting product pricing.

A near real-time system that analyzes the results of each user-set pricing rule by on sales, revenue, profit. The user can then decide whether to change the pricing rule, assign to certain group of SKUs, or leave the current pricing rule. The results of each rule set by the user are measured and reported on the dashboard daily or near real-time, depending on the frequency of feed updating which is set during the implementation.

Furthermore, going beyond simple collecting of data points, the present invention includes an innovative analytics system displaying clear reporting of actual results in terms of sales, revenue and profit. This is how the effectiveness of pricing rules and automation will be measured.

The price is based on how the market actually performs per given merchant store. If the price elasticity experiment is set, then the system connects to the sales history data and identifies the product demand level along with volatility.

Embodiments of the present invention provide many advantages over conventional techniques. For example, according to one embodiment of the present invention, the market price is automatically determined and implemented every 15 minutes. Accordingly, the seller's products are priced in the most efficient manner without requiring the seller to perform any research, market analysis, or price reconfiguration.

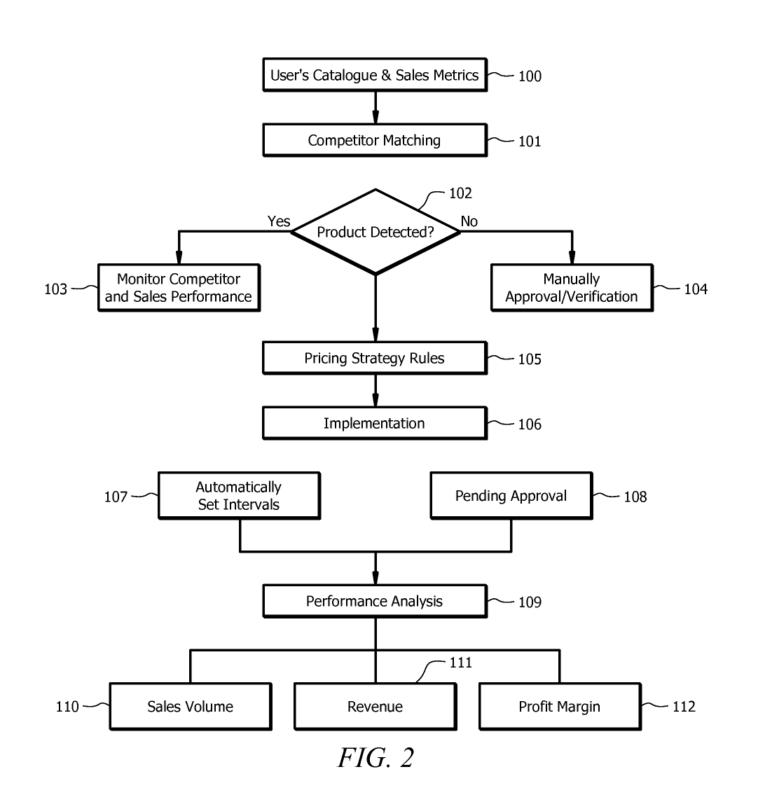

FIG. 2 is a simplified flow diagram illustrating the overall pricing scheme. Step 100 includes defining a seller's catalog. Sales metrics may need to be populated and added given the level of detail that is available and which is required. In step 101, items from the seller's catalog are matched to the competitor's products. Next, at step 102, proprietary data mining algorithms are periodically dispatched to identify similar products based on the sale characteristics of a product. These sales characteristics may include, but are not limited to: the product identification number (SKU, UPC, ISBN, etc.), current list prices of the product, the length of time from list to sale, the final sale price of the product, the condition of the product (good, new, excellent), time and date, and conversion rate. If a competitor's product is identified and matched, then at step 103 the competitor's products and sales performance may be monitored. However, if a competitor does not offer the same exact product, but one or more similar products are found, then at step 104 the method requests a user to manually select one or more products that may be considered competing product.

The method proceeds from steps 103 and 104 to step 105 in which pricing strategy rules are selected for application. Thereafter, at step 106 the selected pricing strategy rules are implemented. In one embodiment, the user is presented with two options of how the new pricing strategy rules will be applied. If the pricing strategy rules are to be automatically implemented, then the method proceeds to step 107. Specifically, the new prices will automatically be implemented to the sales channels (websites, storefront, Amazon, eBay, and/or physical stores). Alternatively, if the pricing strategy rules are to be manually implemented, then the method proceeds to step 108. Accordingly, price changes will not be implemented unless the seller manually authorizes the system to perform the change. At this point the seller may also select the minimum and maximum prices as safe guards.

Performance analysis may be accomplished in step 109. In particular, an analysis platform allows a seller to monitor the progress of the strategies they have implemented. In step 110, sales volume data is aggregated and analyzed. Similarly, in step 111 revenue data is aggregated and analyzed, and profit margin data is aggregated and analyzed in step 112. With reference to sales volume data, revenue, and profit margin, a user has a clear view of the sales trajectory and is able to determine if the rules they chose to implement are providing them the greatest return.

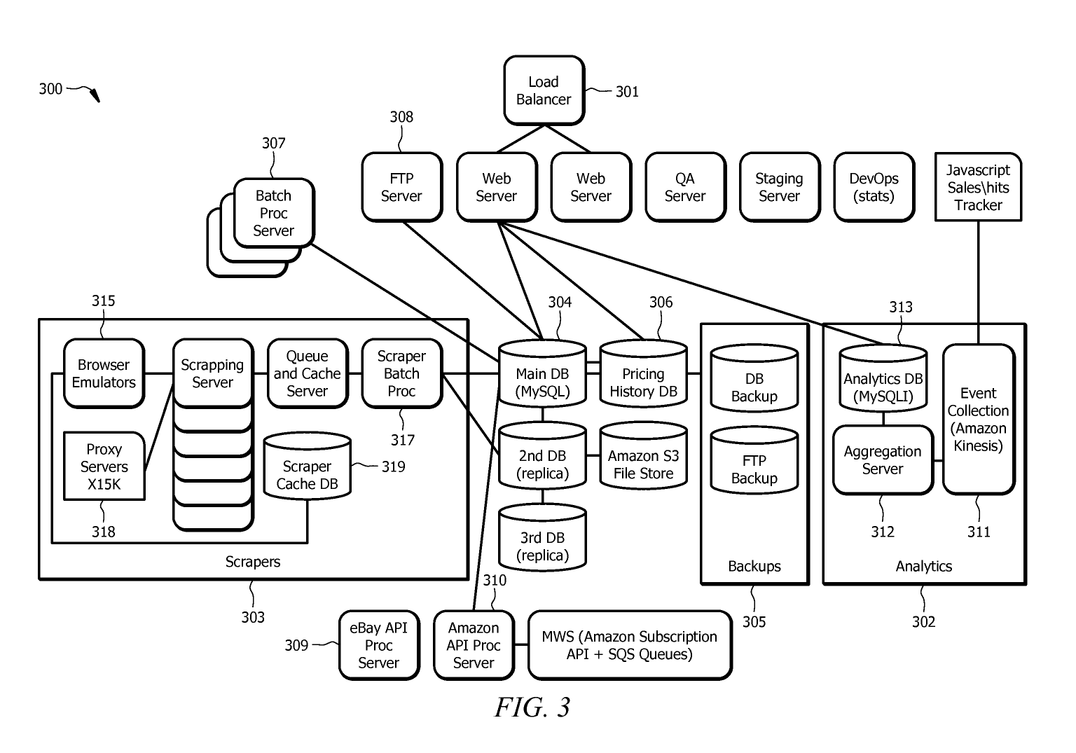

FIG. 3 is a block diagram illustrating the web infrastructure 300 of a pricing system according to one embodiment. The web infrastructure 300 includes web servers connected to a load balancer 301, an “Analytics” component 302, a “Scrapers” component 303, a main data repository 304 and Backups 305, a shared pricing history database 306, a batch processing server 307, and an FTP server 308. The web infrastructure 300 further includes an eBay API Processing Server 309 and an Amazon API Processing Server 310.

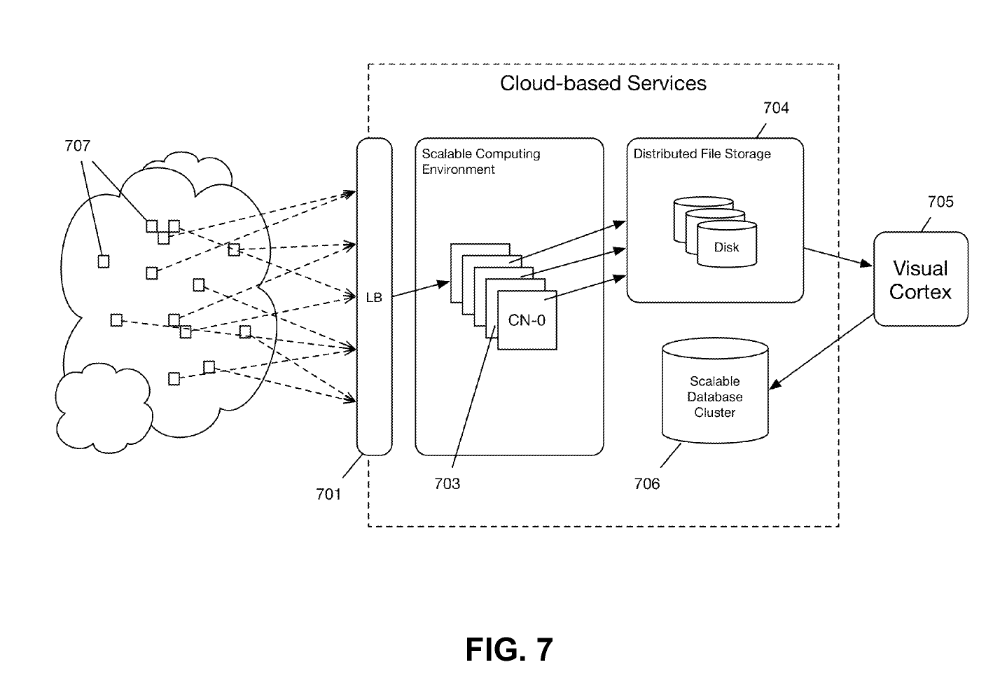

The Analytics component 302 aggregates sales metrics from sellers' webstores that have integrated their shopping cart systems with the pricing system. The Analytics component 302 includes an event collection service 311, aggregation server 312, and an analytics database 313. The event collection service logs impressions from customers who visit the seller's webstore, and receives sales data (e.g., product name, quantity sold, price), streamed from the customer's web browser, upon a successful sale of a particular product. The event collection service 311 may implemented in a number of ways, which will be described in further detail below with respect to FIG. 7. The events collected by the event collections service 311 are aggregated using the aggregation server 312 and persisted in the analytics database 313. The analytics database 313 may be locally hosted with the aggregation server 312, or it may be entirely cloud-based.

In general, the scrapers component 303 is responsible for scraping and crawling operations for the pricing system, including command and control. The scrapers component 303 comprises a scraping server cluster 314, browser emulators 315, queue and cache server 316, scraper batch processing server 317, proxy server 318, and a scraper cache database 319. The platform may be marshaled using an object-oriented API using, for example, Java annotations and objects. Scraper components run across all JVMs in the cluster 314. Furthermore, the scraping server cluster 314 may feature a hot-deploy runtime environment, such as the Wise SuperMiner Runtime. The SuperMiner Runtime is a runtime for executing scrapers created with the Wise Visual Designer. The runtime is used for the launch/debug phase integrated into the “Play” button of the Visual Designer, as well as in production for running scrapes and crawls on independent JVMs. If changes need to be made to a particular scraper design, the scraper may be first tested on a non-production system before being dynamically redeployed to a running cluster.

Also within the scrapers component, browser emulators 315 may be used to generate screen captures of scraped webpages in order to capture evidence of MAP violations. The queue and cache server 316 supports command and control of the scrapers. The proxy server 318 manages a pool of available connections for the scrapers to access the Cloud. If a scraper needs to cloak its IP address to avoid blocking by a particular webstore, the queue and cache server 316 may reschedule the scraper job using a different available connection (i.e. different IP address). The scraper cache database 319 is used to persist any state for scraper jobs.

The Backups component 305 provides period backups of the main relational repository 304 as well as backups of data transmitted via the FTP server 308. Depending on the type of database selected for the main repository 304, the Backups component 305 may permit hot backups of the production database. Hot backups are performed while the database is running and applications are reading and writing to it. This type of backup does not block normal database operations, and it captures even changes that occur while the backup is happening. Hot backups are desirable because they permit the system to be backed up without taking the pricing system offline. For storage engines that do not support hot backups, a warm backup is still possible, but tables cannot be modified while being backed up.

In some embodiments, an API processing server may act as a gateway to certain highly used marketplace platforms, such as Amazon® and eBay®. Instead of scraping such websites directly, the marketplace platforms permit the same data to be collected in a more efficient manner through the use of marketplace APIs. In such an instance, a special-purpose scraper may be designed to obtain pricing data by requesting it via an API. The scraper otherwise behaves as any other scraper from the perspective of the pricing system.

In some embodiments, the disparate data stores may be managed using a single platform that provides a core set of components to accomplish reading from and writing to external data systems, such as local file systems or databases, cloud-based storage services like Amazon S3™, or a distributed file system like Apache Hadoop Distributed File System (HDFS). Other uses may include writing and reading to and from HTTP sources, such as REST APIs and webpages, and writing and reading to and from message queues (e.g., Kafka, ActiveMQ, RabbitMQ). Such a platform may also be used to perform in-memory processing on the JVM heap for power analysis, roll up computations, and to drive a feedback loop/behavior for previous components in the pipeline. The platform may be marshaled using an object-oriented API using, for example, Java annotations and objects.

### Data Gathering

Data gathering is performed with reference to competitor pricing data and also a seller's sales data. The data may be gathered from and processed in the Cloud. Competitive data may be captured through scraping, and a seller's sales data may be imported from or synced from a seller's existing ecommerce platform. An input/output processor may be configured to acquire data on corresponding products and may also be used to identify possible competitors and the competitors' sales characteristics. Non-limiting examples of the competitors' sales characteristics may include competitor pricing, sales performance, conversion rates, the number of available products for sale and traffic.

However, before competitive data can be harvested, the seller must first define a product catalog to gather competitive data for. The product catalog contains a list of the seller's product data. Examples of product data include product name, brand name, model number, product SKU, and price. The product catalog may also optionally include other unique identifiers like UPC, ISBN, or Amazon Standard Identification Number (ASIN). To populate the product catalog within the system, the seller may upload a file in a field-delimited or structured format to the system, which the system then parses and imports into an associated data repository. Depending on the quality of the uploaded data, the seller's product catalog may need to be enriched by filling in gaps with existing product data available to the pricing system. For example, the seller may identify a product by model and brand but omit a UPC. In such a case, the system may be able to match the seller's incomplete records to existing product data in the system that is more complete, and update the records with the missing attributes (e.g., UPC, description, image preview). Once a product catalog has been defined, the system can be further configured to associate competitors with the seller's account, from which competitive data will be gathered.

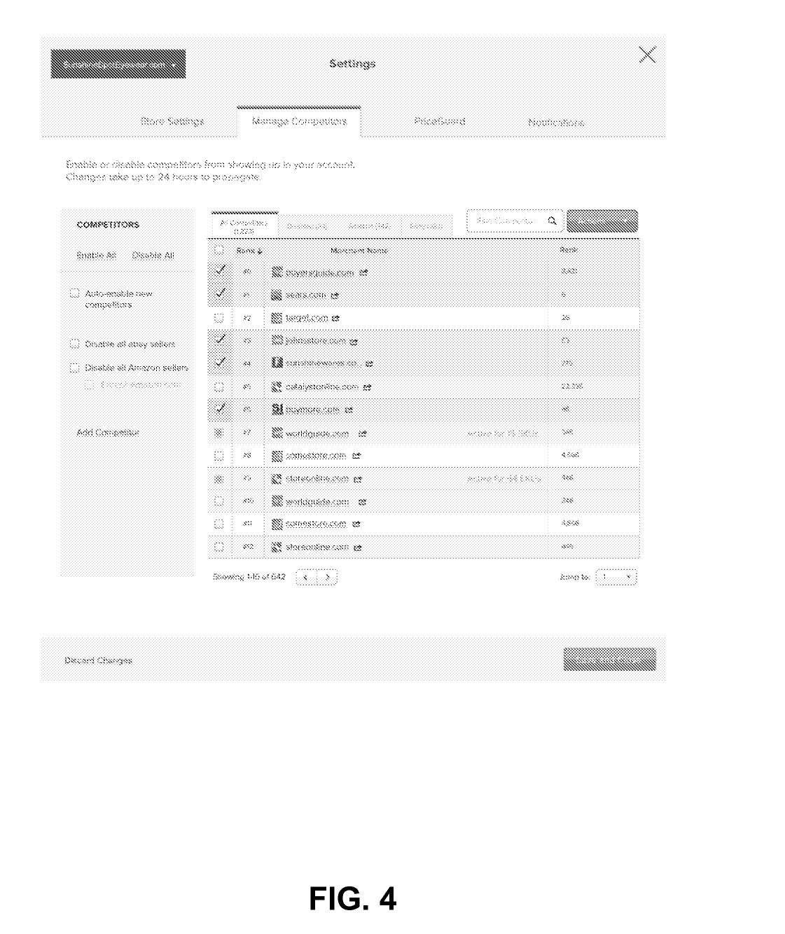

In order to begin monitoring the sales activity of a particular competitor in the web marketplace, competitors are selected from a list of pre-existing competitor definitions. FIG. 4 shows an exemplary user interface for searching for and selecting competitors from a predefined database of competitors. The Manage Competitors Interface is comprised of several views. The main view shows a list of competitors by merchant rank and merchant name, including an indicator of whether the competitor is currently enabled for the seller's account or activated for an assortment of products. The list of competitors being shown in the main view can be quickly filtered by using the search field to search by a merchant's name or URL. A menu view allows the seller to control whether any competitor that is added to the system should be auto-enabled for the seller's account. In some embodiments, the system may allow sellers to request custom competitor definitions that have not yet been made available. In such embodiments, the menu view provides an option for the seller to add a competitor, which will prompt the seller to provide information about the competing merchant, such as name and website, and then submit a request for it to be added to the system.

Activating a competitor for the seller's account adds the seller to the list of competitors the seller is monitoring within the web marketplace. Such a selection has a number of practical consequences. For one, a competitor must first be defined within the system before the system can begin monitoring the competitor's web store for competing offers for selected products from the seller's product catalog. As will be discussed in further detail below, this involves, among other things, creating a custom web scraper or crawler that works with the specific competitor website layout. Additionally, the selection of competitors affects the outcome of certain pricing strategies, such as “beat the lowest price” or “stay with the pack.”

Once a competitor is active, the system described herein will begin gathering the competitor's pricing data from the competitor's web store for products that match the products in the seller's catalog. In one embodiment, the data gathering is accomplished on a platform referred to herein as the exact product-matching platform. The exact product-matching platform is dependent on keyword strings and description of the product that the seller provides. For example, the system may match the sellers' information to the competitors' products based on the product's UPC, SKU, ISBN and specific descriptions.

### Custom Scrapers

Web retailers sell products online through virtual store fronts or web stores. Typical web stores feature home pages with promotional sales content, lists of product categories for browse-based shopping, and product filters or search tools to help consumers quickly locate particular products. When a customer browses or searches a web store, multiple product matches may be shown to the customer on a single page using product previews that may include a thumbnail of the product, its name, its price, and its availability. Clicking on the product preview forwards the customer to a dedicated product page that may provide a detailed product description, product reviews, additional photos, and options to select or preview different product configurations such as color and size.

These product pages may be assigned unique URLs, which can be indexed by search engines to help drive traffic to the web store. Accordingly, many customers arrive at a particular product page as referring traffic from a search engine or from a shopping aggregator like Google Shopping. However, while web stores often adopt similar layouts, each web store presents product data in unique ways. Even two web stores that share a similar visual appearance may be implemented using starkly different HTML structures, feature different field names, and store or display data in subtle different ways. The practical consequence of these differences is that one XPath or CSS selector written to query a particular field for a product page on one site may not work on another site.

In order to gather information of interest from a competitor's web store, the pricing system relies on customized Scraper Components, which are responsible for taking the HTML structures found on various websites and extracting the relevant pricing information, even in the face of changing page layouts and navigational structures.

A scraper may be implemented as a configurable executable or runtime that may be deployed to a workflow server or JVM cluster. An executing instance of a deployed general purpose scraper may configure itself based on a configuration file retrieved from the Cloud and/or possibly from state information persisted in a web-based distributed data store. Alternatively, a special purpose scraper may be designed using a visual designer and then compiled with only the features needed for the designed task.

At least one instance of a custom scraper S_{c,i} will be active for each competitor c, where S_{0,0} and S_{1,0} represent different custom scraper instances that each pertain to a different web store (e.g., Target and Walmart). Additional instances of a particular custom scraper may be instantiated in order to increase scraping throughput. Divide and conquer algorithms, such as MapReduce, may be used to organize the work performed by each scraper. For example, a scraper S_{c,i} may receive a message from the job queue instructing the scraper S_{c,i} to scrape a particular product, represented by subscript i (e.g., Ray Ban Sunglasses RB 1234-GG) from the site of competitor c. Simultaneously, a different instance of the same custom scraper may be assigned to scrape a different product from the same competitor website. However, that instance could not be used to scrape a competitor b, which uses a different layout.

In general, a scraper should be able to support JavaScript, AJAX, cookies (e.g., add-to-cart or login), and operate a browser-based HTML parser, including being able to simulate click events. Such general capabilities allow special scraper sub-components to be developed to handle certain types of product pages. For example, some web stores will not display the actual price of the product unless the product is added to the shopping cart. Therefore, some scrapers will need to be configurable to work with merchant sites that use such features.

A scraper may be configured to preserve images encountered on the competitor's site, which may be defined in an HTML string (usually hosted on the competitor's site or at an edge server/CDN), upload them to a distributed file system like Amazon S3, and then return a URL pointing to the S3 image.

A scraper may also be configurable to determine a price that depends on the selection of a particular shipping speed or for sites that require a zip code in order to display price.

Units of measure can present another challenge for scrapers. For example, a seller may offer a 12 pack of instant brew coffee pods for $12.99. However, a competitor may offer the exact same brand of instant brew pod but in a 24 pack. In such a case, the scraper will look for the Unit of Measure (UOM) in the text on the page based on a list of defined phrases or within a field in the product detail. When the scraper finds a product with a UOM on the page, it will pull in the Price, Quantity, and the Unit price (calculated). When the scraper finds a product without a UOM it will store Null for quantity and ignore the Unit price.

In operation, a scraper must be configured to work within the bounds of a particular site structure and page layout. Scrapers must be able to handle corner-case scenarios, such as different page layouts, throttling conditions, GeoIP cloaking by target websites, etc. For sites that offer a product search feature (fairly common), the scraper may be able to find the product page directly by querying based on identifying criteria, such as UPC or Brand/Model. If the site returns a product hit, the scraper navigates to the product page, scrapes it, and then validates that the data scraped matches given criteria, for example, an arbitrary string, UPC, Brand/Model, or expected price range.

A scraper will attempt to use exact matching where the seller provides product identifiers, such as SKU, UPC, ISBN, or ASIN, and the competitor being scraped provides such data on its product pages. However, where exact matching is not possible, fuzzy matching may be used to try to obtain a match. For example, brand and model (e.g., “Apple iPhone 6”) may be used to try to match to a particular product. In other cases, a combination of technical specifications may be used, such as, processor speed, memory, hard drive size, monitor size, etc., to identify a particular model or its close equivalent. Additionally, data scraped from a reliable second source may be used. For example, a shopping aggregator like Google Shopping, may produce a list of competitors that offer the searched for product at a particular price. Such shopping aggregators offer highly accurate snapshots of competitor pricing, which may be used to verify or search for the product on the competitor's actual product page. In other words, if several products are returned by scraping or crawling the competitor's webstore, a price range derived from known prices may be used as a tie-breaker to determine which of the product matches is the correct product.

Some scrapers may support conditional branching in the process flow. For example, when a particular UPC fails to return any results on a particular competitor's web store, the scraper may attempt to query the product using a fuzzy match, such as by brand and model.

Some competitor sites take active steps to prevent their web stores from being scraped or indexed. For example, a hostile site might block a crawler based on its IP address. Scrapers can also be blocked by excess traffic monitoring based on frequency of request and user agent. Instead of refusing the Scraper's HTTP GET request (blocking), the site may instead challenge the Scraper to prove it has human intelligence by presenting it with a CAPTCHA.

Scrapers may be configured to work with proxies using a proxy service and API so as to mask the true origin IP address of the scraper in order to operate without getting blocked. If the scraper gets blocked, it should be able to switch to an alternate proxy and wait to be scheduled again using the new proxy information.

In addition or in the alternative, the scraper may also support throttling to limit the rate at which a domain is crawled by the scraper. In particular, throttling may be necessary in the event that fetching components of the scraper detect that the website operator is attempting to throttle the scraper and/or unable to cope with the scraper's request rate against their systems. For example, WiseThrottle is a component that throttles use of any resource. In the scraper context, WiseThrottle is used to throttle calls to different domains according to a pre-defined list in the configuration file. When pulling a scraper message from the general queue, the scraper process checks if it can process the request based on the list of custom scraping sites attached to the message. If the message needs to be throttled, the process moves it to a different queue. Every X iterations of the scraping process (X can be set in the scraper command code), the process will pull a message from the throttled messaged queue instead of the main queue.

A data distillation layer may be used to translate raw data collected by the scrapers into a distilled version. The “distillation” process is used fill out missing entries with best estimates, corrected data, and apply certain data integrity rules to the data. For example, if historic price data is missing (for the seller or for competitors) the data distillation layer should fill forward by pulling forward the last recorded price per day. In other cases, data may need to be discarded. For example, if sales data has a product price more than 70% different than a trailing seven-day average, the entry may need to be discarded in favor of a rational default value. However, in some cases, missing data may simply be a result of a lack of sales activity or web visits for a particular day and, therefore, no corrective action should be taken.

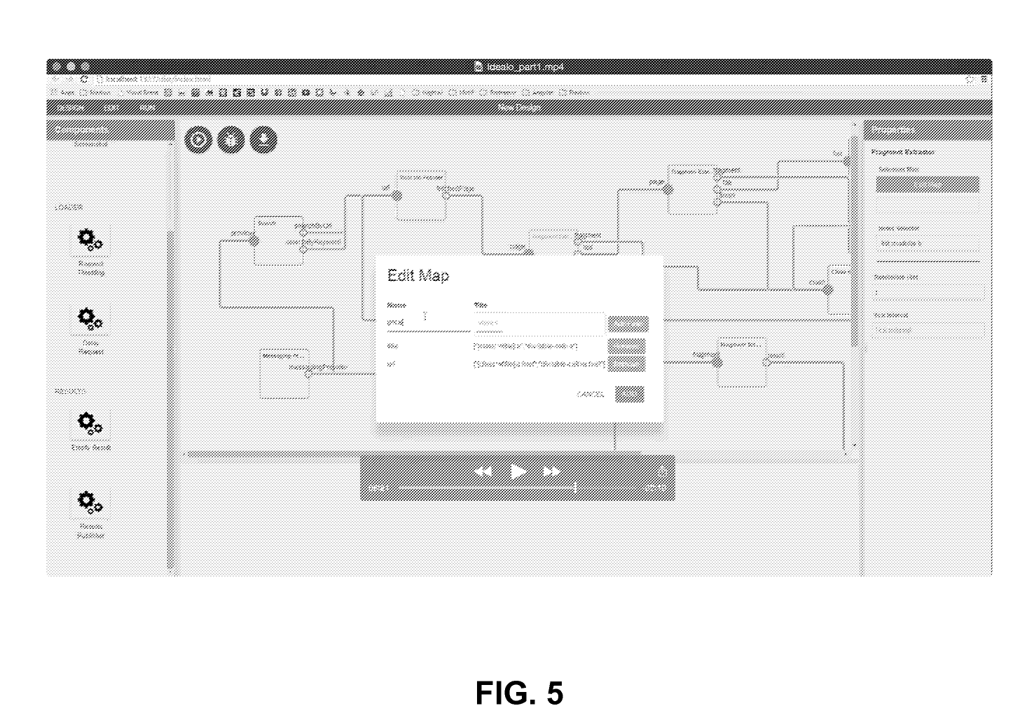

Because each Scraper must be customized to work with a particular competitor's website, the pricing system may provide a visual designer that can be used to wire scraper subcomponents together to create the scraper. FIG. 5 shows a screenshot from Wise Visual Designer, which allows scrapers to be assembled from subcomponents that are wired together using the inputs and outputs of each particular subcomponent.

### Custom Crawlers

In contrast to a Scraper Component, a Crawler Component is deployed where it is not possible to locate a single match using the competitor's search feature to query based on a set of unique criteria. Instead, the crawler must crawl a site based on a site map or product categories. In order to narrow the number of results the crawler must go through, the crawler may be able to rely on price-range filters to narrow the field of search.

Because crawlers cannot be as efficient as scrapers (i.e. cannot jump directly to the result), crawlers often run into throttling issues much more quickly because of the increased interactions with the competitor's site. Additionally, some sites cap the number of results that can be returned by a query. For example, if the crawler requested all products between $0-$100 and the site caps the number of results that may be returned at 1000 (out of 9783 available results), additional partitioning techniques will need to be applied in order to get around the arbitrary limit set by the web store. In one embodiment, the crawler may be configured to narrow the price band it uses first to $0-20, for example, crawl the results if the number of results returned is under the hard cap, and then proceed to the next partition, which may be the price band between $20-40.

Crawler results may provide exact matches with products in seller's catalog, in which case the results are stored in memory for further processing by a pricing automation component. However, if a product from a seller's catalog is a near match but not verified as an exact match, then the seller has the option of manually approving the near match(es) as either an exact match or a substitute match to allow the system to track the product for pricing purposes. Manual approval may take one of two forms. In the first, crowd sourcing APIs may be utilized to resolve ambiguous results. In the second, a user-assisted match may be implemented. In either event, the manual approval may be accomplished with reference to stored product data for the near matches. The stored product data may include a product image and any product attributes that are available.

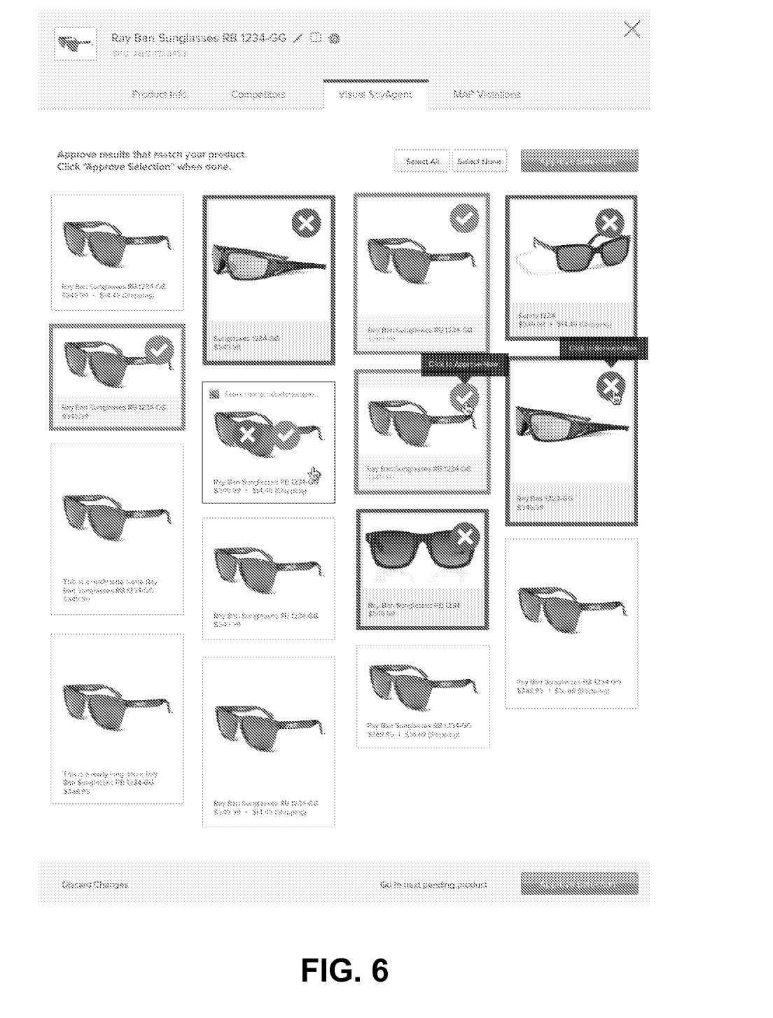

Crowd sourcing APIs typically rely upon outsourced human intelligence and interaction to make the decision regarding whether a near match is an exact match or a substitute match based upon knowledge of products in the seller's catalog. Compensation is often required for those services; thus, the crowd sourcing API option may be implemented up until a certain specified budget. Thereafter, user-assisted matching may be implemented. FIG. 6 provides an exemplary user interface that may be supplied to a seller for purposes of resolving near matches.

In particular, FIG. 6 depicts a collection of near matches returned by a crawler. In this embodiment, the near matches are displayed in a grid fashion with each product represented by a corresponding product thumbnail. An example of an unreviewed product is depicted in the upper-left of the grid. Hovering over an unreviewed product provides a user with the option to identify the product as a match or to discard the product as unrelated. A user may select either option based upon preexisting knowledge of the items in the seller's catalog. In the illustrative example in FIG. 6, items that have been identified as matching a product in the seller's catalog have been identified with a checkmark icon. Items that are identified for discard are marked with an X icon.

### Web Beacons

According to one embodiment, the server integrates with the seller's system by assimilating their catalogue and analyzing metric information.

FIG. 7 illustrates a subsystem 700 for tracking sales data using a cloud-based web infrastructure. The subsystem 700 is comprised of: a load balancer 701; a cloud-based scalable computer environment 702, which hosts a configurable virtual machine cluster 703; a distributed file storage system 704, such as Amazon S3™; a data processing subsystem 705, and a cloud-based scalable database cluster 706.

Web beacons 707 may be deployed on the seller's site to monitor page impressions, conversions, and other sales metrics. A web beacon is a lightweight script that is served to a customer's browser along with a web page, which in this case would be a product web page on the seller's web store. The customer's browser executes the script automatically when rendering the product page, which causes the customer's browser to download a single transparent pixel from the pricing system. The download request, which provides the requestor's IP address and the time of the request, represents an “impression” that can be used to track interest in a particular product page.

A web beacon 707 may be deployed using the URL of the load balancer 701, and the load balancer 701 routes the request to an available server instance 708, nicknamed a cranial nerve because it conducts pixel views to the data processing system known as the “Visual Cortex.” The system can be scaled up as the number of web beacon traffic increases by provisioning additional server instances within the scalable computing environment 702. Each cranial nerve 708 is responsible for unpacking and logging the web request to the distributed file storage system 704. The Visual Cortex 705 may fetch the files from the distributed file storage system 704 on a periodic basis (e.g., every 15 minutes, 30 minutes, or hourly) and process them. Once the sales data has been processed, it is stored in the pricing system's sales database.

In an alternative embodiment, the load balancer 701, scalable environment 702, and distributed file storage system 704, may be substituted with a commercially available web analytics platform, such as Google Analytics™ or Amazon Kinesis™.

The event collection service automatically tracks sales and impression data. In one embodiment, asynchronous JavaScript pixel technology may be used, which means the embedded script makes a request to start loading the page but nothing blocks waiting for the script to load. To integrate the pixel tracker with a seller's webstore, two code snippets may be inserted: one on the product page and one on the order confirmation page.

For example, on both the product page and the order confirmation page, the following code should be inserted into the Head tag:

<script src=“https://s3.amazonaws.com/wpanalytics/web/w.js”></script>

The tracking script may be invoked by linking it to an “onload” event in the body tag of the webpage.

<body onload=wise_load( )>

In order to configure a seller's webstore to integrate with the pricing system, the embeddable script must send a Store ID and API key, which is provided by a Wiser Product Specialist.

For example, the following script might be embedded in a product page in order to tell the pricing system which store the customer purchased the product from:

<script>

wiseAnalytics.init(‘API_KEY’, STORE_ID); function wise_load( )
{
wiseAnalytics.track(‘view’,{page: ‘product page’, sku:
‘PRODUCT_SKU’}) }

</script>

### Shopping Cart Integration

The pricing system may collect a seller's order data through a JSON array called sales. In order to send data from the order confirmation page, the seller will need to pass the list of products being ordered to the pricing system. For example, the list of products and order information might be submitted to the pricing system using the following format:

myProductList = [

{page: ‘cart page’,sku: ‘MY_SKU’, qty: ‘QUANTITY_SOLD’,

revenue: ‘REVENUE_BY_SKU’},

{page: ‘cart page’,sku: ‘MY_SKU’, qty: ‘QUANTITY_SOLD’,

revenue: ‘REVENUE_BY_SKU’}

]

Each object in the list should represent each product being ordered. Once the list is in the proper format the wiseAnalytics object needs to be initialized with the proper API key and store ID, and then call the sales method.

<script>

wiseAnalytics.init( ‘API_KEY’, STORE_ID); function wise_load( )
{
wiseAnalytics.sales( myProductList) }

</script>

The product list passed to the analytics system should be in the same format as the array of objects defined above (list of products in each order).

PRODUCT_SKU is the SKU number that the seller uploaded to the pricing system, which should match with the Wiser configuration. For example, if the user loads SKUs into the pricing system with leading zeroes (e.g., “00012305”), the SKUs passed from the checkout page to the analytics service must also have leading zeroes. QUANTITY_SOLD is the quantity associated with each SKU in the order. REVENUE_BY_SKU is the total revenue associated with each SKU in the order. For configurable product pages (e.g., a shirt that comes in more than one color), all of the underlying simple products (i.e. a blue shirt, a green shirt, a red shirt) should be sent to the analytics system.

### Dynamic Pricing Automation

The following provides a high level description of steps for setting a pricing strategy for a particular set of products. In one non-limiting example, setting the pricing strategy can be accomplished in four discrete steps which is facilitated by specially designed user interfaces for guidance. In a first step, an overarching strategy is selected. In a second step, the set of products are selected. In the third step, the pricing strategy settings may be viewed, selected, and/or altered. In the fourth step, confirmation is solicited.

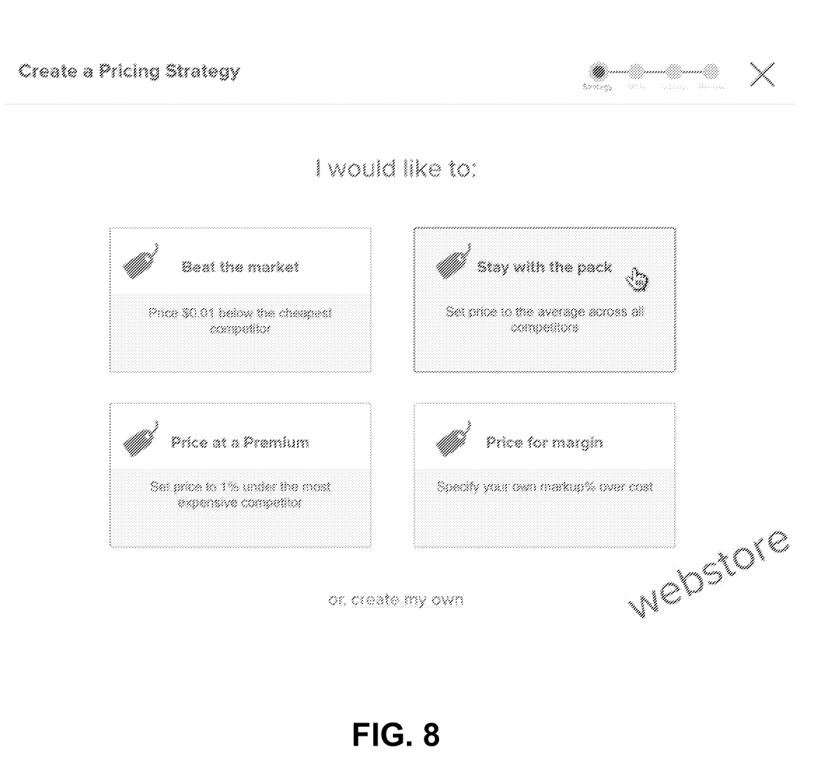

FIG. 8 depicts an example of a user interface for facilitating the the selection of a pricing strategy in accordance with an illustrative embodiment. The user interface may list any number of pre-defined pricing strategies. These options may be presented with a unique descriptor and optionally a short summary providing some insight describing a manner of operation. The options may be displayed in a number of different ways, such as in a list format. In the alternative, the options may be presented as selectable icons in a grid format. Any number of text-based prompts may be provided on the user interface to guide the proper selection of a pricing strategy. More advanced users may choose to select options to create a customized pricing strategy. A particular pricing strategy may be selected by operating an I/O device, such as keyboard, mouse, or touchscreen to select an icon or list element corresponding to a desired pricing strategy.

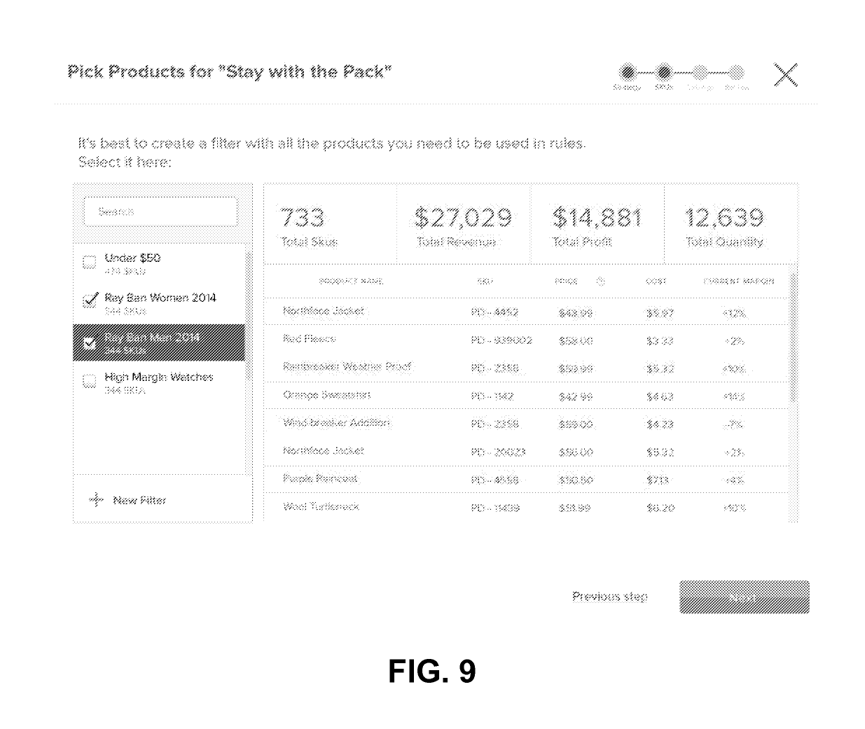

After a pricing strategy has been selected or created, a subsequent user interface may be provided that assists in the identification of one or more products for product grouping, which is shown in FIG. 9. Product grouping refers to the process of identifying a subset of products to which the selected pricing strategy will be applied. Discrete items may be uniquely identified by a universal identifier, such as a bar code or SKU, and grouped to facilitate a manner of finding and selecting products. Products can be grouped in any number of ways. In a non-limiting example, the products may be grouped based upon type. Thus sunglasses may be grouped generally in a single large group. Alternatively, groups can be further subdivided based upon any number of categories such as price range, brand, or target gender. Groups can be subdivided based upon pre-determined criteria as listed above. Further, options can be presented that allow creation of customizable filters that allow more granular selection criteria. Appropriate searching tools such as a search toolbar may be provided to find particular items.

In a non-limiting embodiment of the user interface for product grouping, the user interface may be divided broadly into two separate views. In a first view a searching toolbar and filter tool may be presented. This first view may also provide one or more pre-defined categories of products for inclusion in a product grouping. The groups may be selected using any currently existing or later developed mechanism, including the toggling of a radio button, selecting a checkbox, or selecting a dropdown menu item. Once selected, the items that form the product grouping may be displayed in the second view of the user interface. Each item may be presented on a row of a table, and the row may display relevant information for the item. The information may include, for example, the item's SKU, a price, a cost, and a current margin. In one embodiment, a portion of the second view may include a product grouping summary which provides a snapshot of selected information. As an example, the summary may display a number of items that form the product grouping, list a total revenue associated with the product grouping, a total profit, and a total quantity.

Appropriate navigational tools may be presented, such as an on-screen button that permits navigation to the previous user interface usable to select a pricing strategy, or a button that allows navigation to the third step in the pricing strategy process.

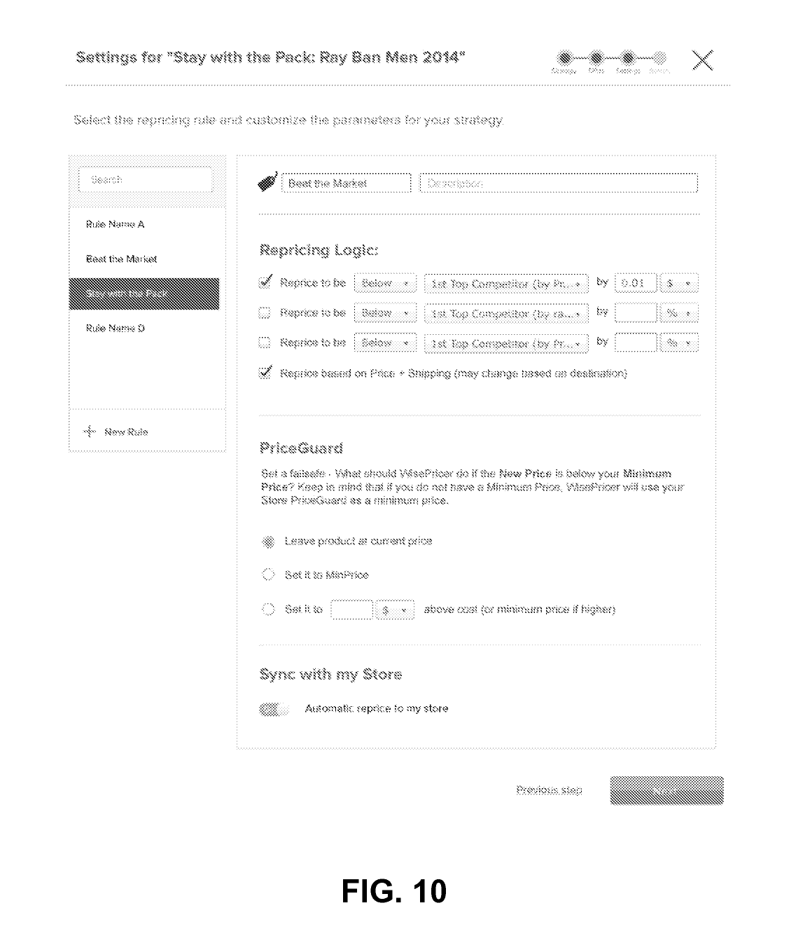

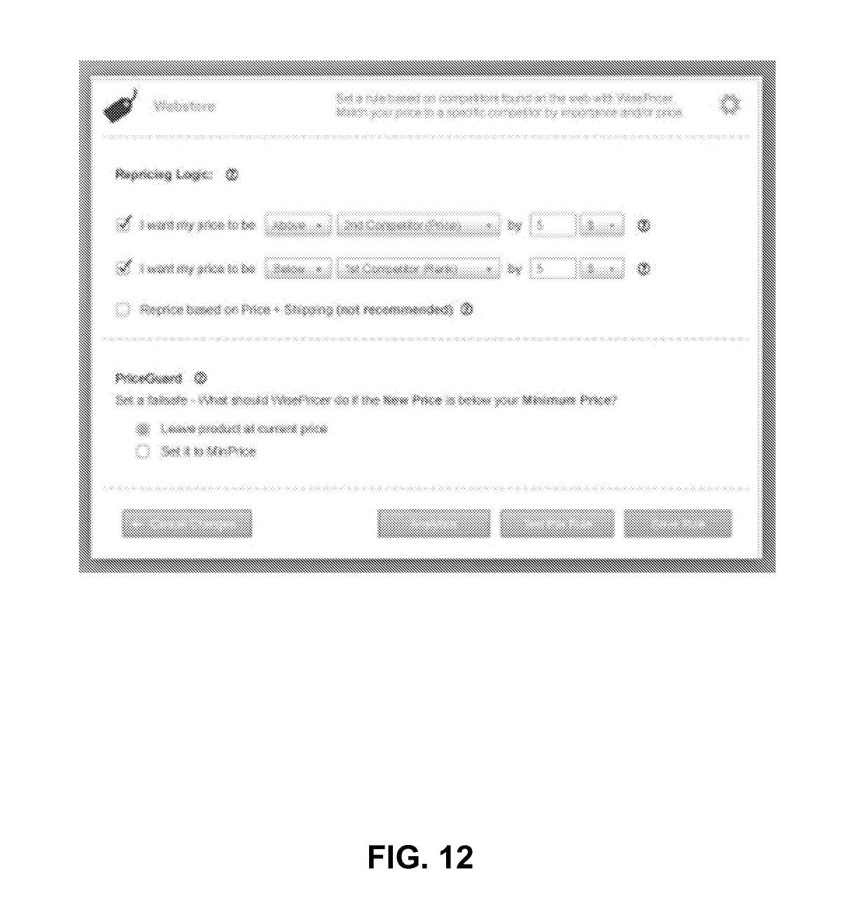

FIG. 10 depicts an exemplary user interface for customizing a selected pricing rule. In particular, the user interface displays a selected pricing rule and provides tools for customization. In an exemplary embodiment, the third user interface is divided into two views. In a first view, the various rule names may be presented and the active pricing rule may be highlighted. Pricing rules may be re-selected by choosing a different rule. Rules that are not shown may be found by utilizing the searching toolbar. In the alternative, a new rule may be added by selecting an appropriate on-screen button. In the second view of the third user interface, various rules that form the selected pricing rule are displayed. A more detailed discussion of these various pricing rules are presented later with respect to FIGS. 12-18 that follow.

As with the second user interface, the third user interface may also include appropriate navigational tools in the form of an on-screen button that permits navigation to the previous user interface or the next user interface.

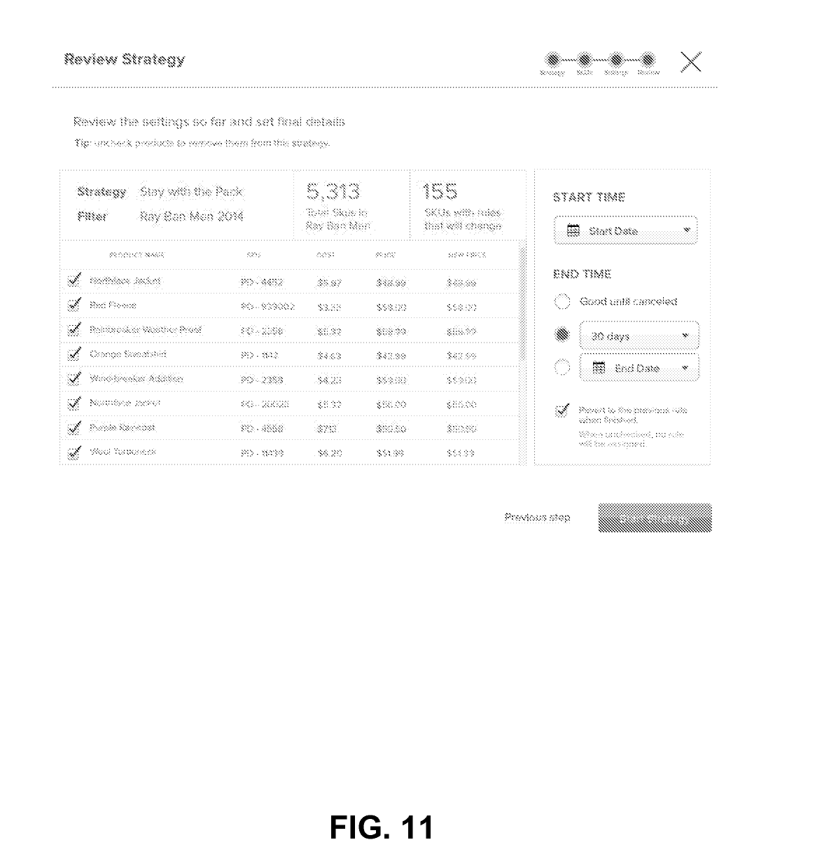

FIG. 11 illustrates another user interface for reviewing and confirming selected settings. As with the previous user interfaces, the fourth user interface may be divided into two view. The first view may provide a comprehensive listing of each of the various products that form the product grouping. The comprehensive listing may be in the form of a table, or some other data structure. Each product may be shown with a number of identifying fields, such as the SKU number, cost, and various prices. The user interface may provide a last opportunity to remove a particular item from the product grouping by toggling a checkbox, radio button, or other similar selection mechanism.

The first view may be further subdivided to include a summary section that identifies the pricing strategy, one or more filters that have been selected, a total number of SKUs that form the product grouping, and a number of SKUs with rules that will change.

In a second view of this fourth user interface, timing information is presented that allows selection of a start time upon which the rule takes effect, and an end time upon which the rule is no longer effective. Start times and end times may be provided in any currently existing or later developed means. Thus, in one non-limiting example, selecting an on-screen button may present a calendar with selectable dates. Various other options may be provided that obviate the need for selecting particular dates. For example, one option may be provided that requires a user to specifically cancel a pricing strategy before it will be terminated. Alternatively, a pre-determined length of time may be toggled.

Once the various settings have been confirmed on this fourth user interface, appropriate navigational tools may be provided to allow a user to navigate to a previous user interface or initiate the selected pricing strategy.

A price normalization layer may be used to perform surface checks after the pricing engine has run. For example, the price normalization layer may round the calculated optimal price to the nearest $0.49 or $0.99 for identified SKUs. Similarly, the price normalization layer may round a price to below the shipping price if it is within a certain threshold set by the user (e.g., an optimal price of $22.99 may be lowered to $19.99 if shipping is charged for orders below $20).

A price normalization layer may also be used to verify bulk goods are properly priced. For example, goods should not be automatically priced such that five ten-packs of a particular good would be cheaper than a fifty-pack. A user may also require color configurations to be corrected after pricing. Certain colors are more popular and therefore an optimally priced product may result in price variances between the various color options. However, a seller may want to always offer the product at the same price regardless of the color option chosen. Therefore, a price normalization layer may be used to correct discrepancies in pricing.

Pricing changes may be formatted into universally accepted output and pushed to one or more user systems. In a non-limiting example, the output may be in CSV format which can be received and implemented by user systems. Pricing changes reflected in the output may be used to change pricing information in a user's webstore.

### Repricing Rules

The system then applies dynamic pricing algorithms based on the data captured to generate the optimal product price. Various segmenting algorithms may be used, such as strategies on conversion rates, time of day and/or based on competitor pricing. For example, a seller may choose to price within 1% of a specific competitor. A different user may base the strategy on conversion rates, where a product's price will drop until the desired conversion rate is achieved. The dynamic pricing system may store or derive information, which reflects the captured variables and subsequent analysis. Examples of repricing rules will be discussed in further detail below.

Adjust Your Price According to the Competition.

The system allows the user to react to competitor pricing changes. If a competitor lowers their price, the user, through the system, can follow suit. For example, if a top competitor has an item priced one cent below the user, a rule can be set to match that price. If this specific competitor's product goes out of stock, buyers will be incentivized to purchase the product from the seller instead.

In some embodiments, the competition rule may be further configured to adjust the seller's price by specifying the amount, either in dollars or percent, to stay above or below a specific competitor by its importance (this is the rank set in the competitor definition) and/or by price. FIG. 12 shows an exemplary user interface for configuring a pricing a strategy based on any competitor found on the web. For example, the rule could be configured in such a way so as to beat the product price of the first-ranked competitor, in terms of specified importance to the seller, by $0.50 but to stay above the price of the second-ranked competitor, based on price, by $0.50. The ranking of competitors in terms of specified importance to the seller may differ from the ranking of competitors in terms of competitiveness on price. The competition rule can be also configured to work with other ranked competitors (e.g., third, fourth, fifth, etc.) or particular competitors (i.e., Target® or Walmart®).

By configuring the competition rule in different ways, the seller could command the system to automatically price a set of products to beat all of her competition or to beat most of the pack, but to stay behind the leader by a certain amount. In some embodiments, a seller may have to option to factor in advertised shipping prices or estimated taxes when computing the most competitive price. For example, the seller may currently offer a pair of shoes for $39.80 while the first-ranked competitor (based on price) offers the same pair for $42.00. However, if the seller charges $5.99 for shipping and the first-ranked competitor offers free shipping, the system would have to adjust the seller's product price to $35.51 in order to beat the first-ranked competitor by $0.50.

Moreover, some embodiments may also feature a minimum price setting, below which the rule will no longer be applied. Such a feature may provide an important sanity check against unintended manipulation by third-parties or lemming-style bot crashes where every competitor uses automated pricing to beat the lowest price such that the market price is driven to near zero.

In addition, some embodiments may allow the seller to test the configured competition rule by previewing how a given set of SKUs would be repriced under it. Such a feature can help the seller detect unintended configuration mistakes before setting the rule active for the system.

Web marketplace platforms, such as Amazon® and eBay®, may be handled in special ways by the system. Such platforms attract millions of daily views and can represent an important source of revenue and click-throughs for a seller. For example, Amazon® offers a “Buy Box” feature, which prominently displays the top three featured sellers for a particular product next to the “Add to Shopping Cart” or “Buy Now” interface on the product page. Because of the prominent placement of Buy Box merchants (as compared to other merchants, which are relegated to another page), Buy Box Merchants see much higher sales and can generally charge higher prices because consumers are unaware of or unwilling to examine the other competing offers that are shown on a separate page (requires another page jump). In order to win the Buy Box for a product (be featured as a merchant in the Buy Box), sellers must generally offer some of the most competitive prices for a particular product.

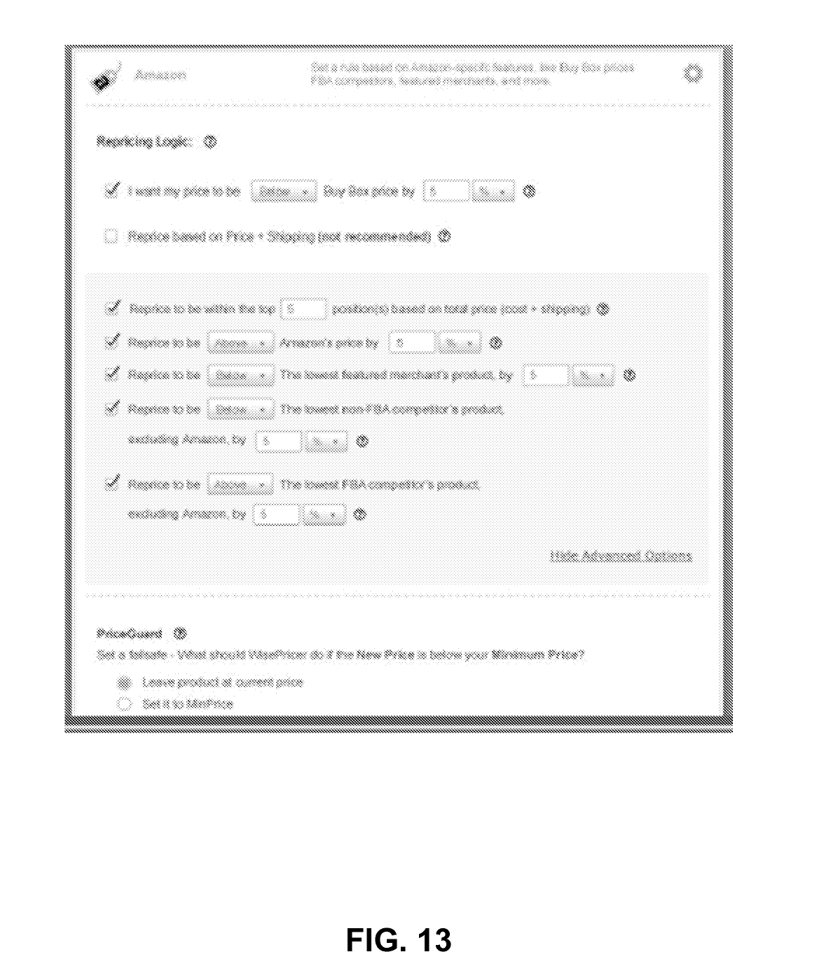

FIG. 13 shows a user interface for configuring a dynamic pricing rule based on Amazon-specific features, such as Buy Box, Fulfilled-by-Amazon (FBA) competitors, featured merchants, etc. Using such an interface, the seller may configure a special pricing strategy to beat the Buy Box merchants' best price by a certain dollar or percentage amount in order to try to win the Buy Box. In some embodiments, the system may offer advanced settings that permit the seller to configure the pricing rule to compete based on Amazon's price or the prices of other unfeatured merchants, whose offers are hidden from view unless the user clicks on a special link (i.e. “used & new”). Likewise, the system may permit the seller to configure the pricing rule to compete based on merchants who rely on Amazon's distribution system, or to ignore such merchants, which are more competitive on shipping costs because of fulfillment by Amazon. The system may also present the seller with the option of taking shipping price into account. Like other pricing strategies, a price floor for the product may be set to safeguard the automated pricing from setting the price to low in an effort to stay ahead of the competition.

As an example, the algorithm underlying the Amazon pricing strategy might function as follows. If the seller is currently in the Buy Box, increase the product price in intervals of 0.25% every fifteen minutes until the Buy Box is lost. If the seller is not listed in the Buy Box and the pricing system has not lowered the price yet (e.g., this is the first time the pricing rule has been executed or the seller just lost the Buy Box), find the Buy Box price, then set the price for the product $0.10 under the current Buy Box price by $0.10 (or whatever amount the seller specified using the configuration user interface). On the other hand, if the seller is not listed in the Buy Box and the pricing system just decreased the price, continue decreasing the price by the specified amount every fifteen minutes until the Buy Box is won or the minimum price set by the seller is encountered.

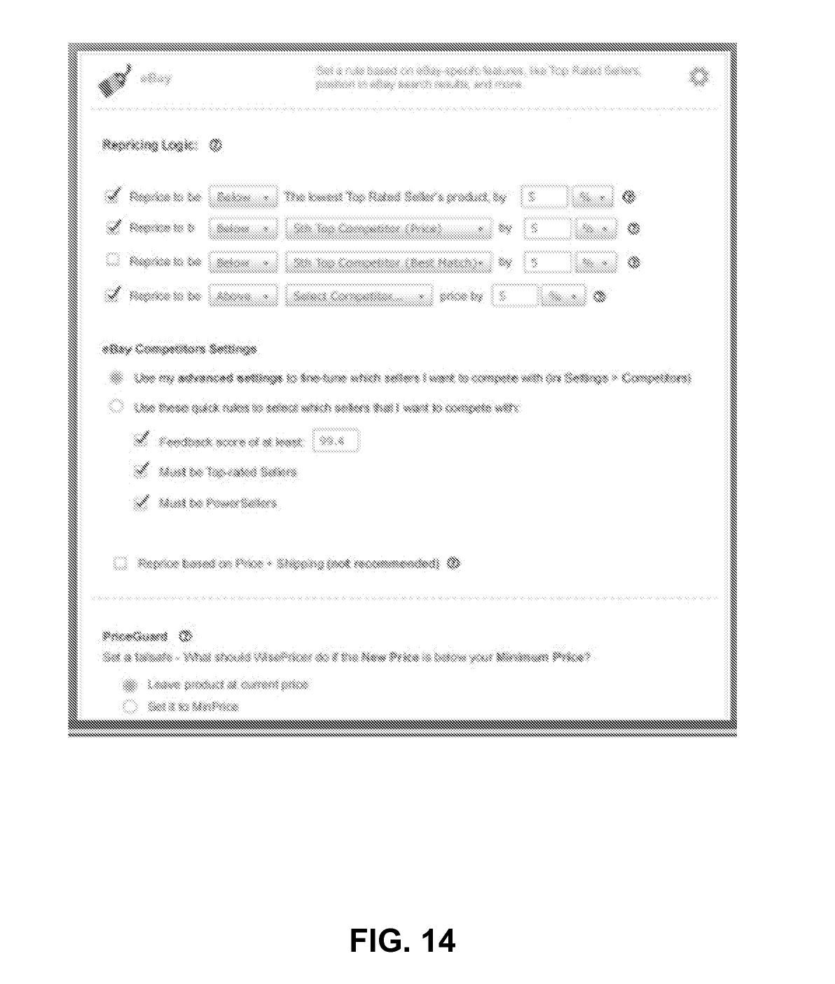

FIG. 14 shows a user interface for configuring a dynamic pricing rule based on eBay-specific features, such as Top Rated Sellers, position in eBay search results, etc. Using such an interface, the seller can configure the pricing rule to achieve certain strategic goals within a marketplace platform, such as eBay®. For example, the pricing rule could be configured to beat the fifth-most top seller based on best match (where the results are ranked according to the best match based on a buyer's search query), or to be above or below the third-most top seller based on price. The system may also offer advanced configuration options, such as an option to disregard competing prices from competitors who are below a certain user satisfaction threshold, or who do not have a special platform status, such as “Top Seller” or “Power Seller,” which require the competitor to meet certain platform criteria, like a certain number of sales, positive reviews, length of time on the platform, number of complaints, etc.

Like other pricing strategies, the seller can also opt to consider or ignore shipping costs, or to set a minimum price below which the product cannot be repriced.

Adjust Price at a Specific Time of Day.

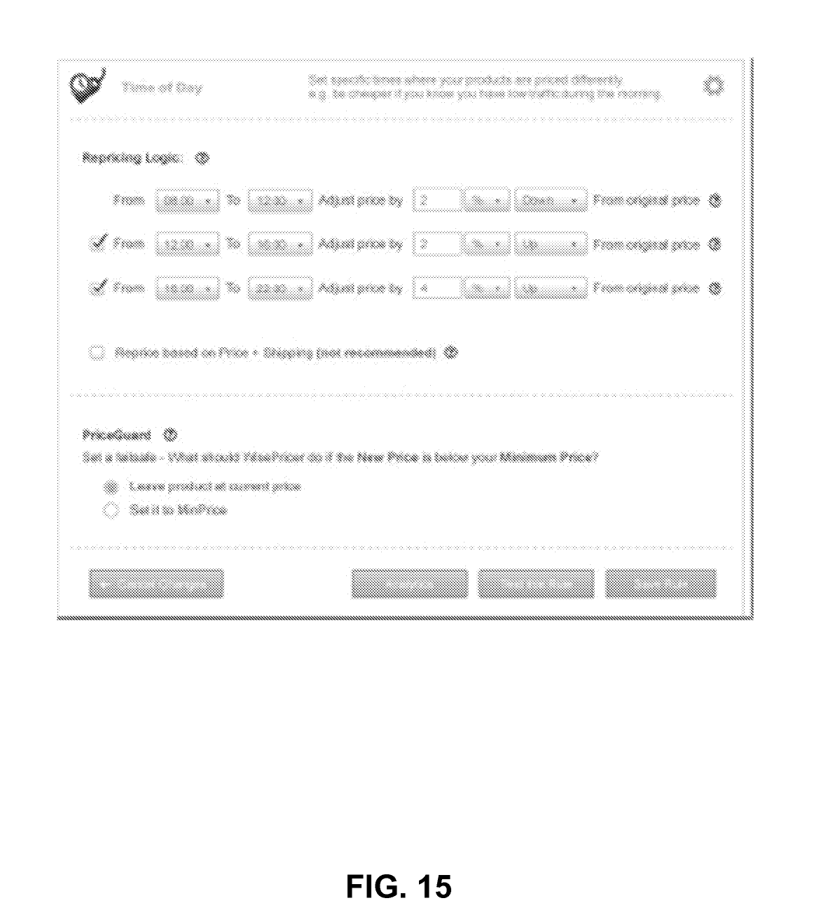

The system allows users to set demand-based rules. Online stores are not terribly different from those in a shopping mall. There is almost no traffic in the morning and little business in the afternoon. Evening is the peak time. Users can set a rule to price higher when more shoppers are ready to buy. As an example, FIG. 15 shows a user interface for configuring pricing strategies that depend on the time of day. Using such an interface, the seller may set specific times where his products are priced differently during high and low traffic periods. As FIG. 15 illustrates, the seller could configure the pricing rule to adjust the price two percent lower from the product's original price between the hours of 8 a.m. and 12 p.m. In further illustration, the seller could set the product price four percent higher from the product's original price during 4 p.m. and 10 p.m., when shoppers are most likely to visit the seller's web store. Other variations based on time range, percentage or fixed amount, and price increase or decrease are also possible. Like other pricing strategies, the seller can also opt to consider or ignore shipping costs, or to set a minimum price below which the product cannot be repriced.

Adjust Price According to Web Traffic.

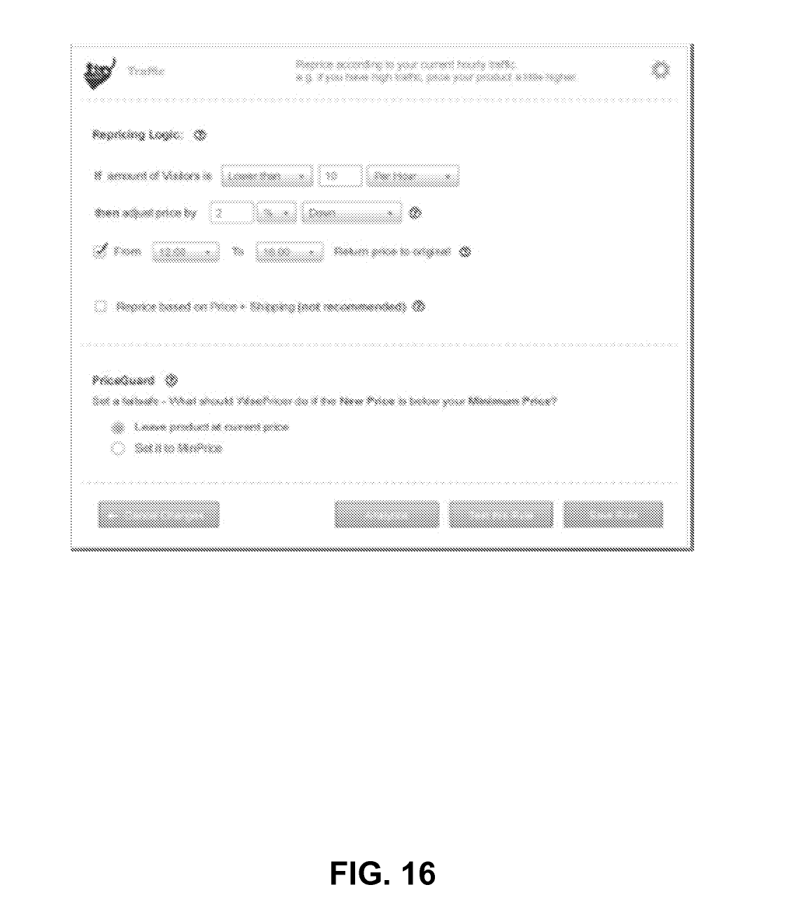

The system can pull traffic data to allow the user to set an automated re-pricing rule including that variable. Measuring the traffic for specific items can indicate what products should be re-priced higher or lower. When the demand is low, the price can be dropped to stimulate demand; when the demand is high, the price should be raised to optimize profit. The system enables web traffic to be reflected in profitable pricing decisions. For example, FIG. 16 shows a user interface for configuring a pricing strategy based on incoming traffic. Using such an interface, the seller may reprice a configurable amount according to the seller's hourly traffic. In general, increased visitor traffic to the seller's web store or to the particular product page represents a secondary indicator for positive demand for a particular product. Accordingly, such a pricing rule can be configured to adjust the price up or down (by fixed amount or by percentage) based on changes in the rate of visitors. Although not shown in FIG. F, other embodiments may permit the seller to configure whether the product pricing should be based on fluctuations in site traffic (as a whole) or the number of visits to a particular product page. Such a feature may allow the seller to increase the price of a particular product in response to a sudden flood of interest in that particular product without increasing the price of unrelated products, which might negate any gains. For example, if a popular blog publishes a positive review for a particular model of a pair of climbing shoes and then links to the seller's site, the seller may wish to instruct the system to automatically adjust the price of the climbing shoes upwards, but would not necessarily increase sales by repricing pots and pans.

In some embodiments, the traffic-based pricing rule may be further configured to ignore traffic-based price adjustments during certain time periods. For instance, if the seller chooses to discount products based on low site traffic in an effort to stimulating demand, the seller may also choose to configure the rule to return the discounted products to their original price during primetime hours, such as from 4:00 pm to 10:00 pm.

Like other pricing strategies, the seller can also opt to consider or ignore shipping costs, or to set a minimum price below which the product cannot be repriced.

Adjust Price Based on Conversion Rate.

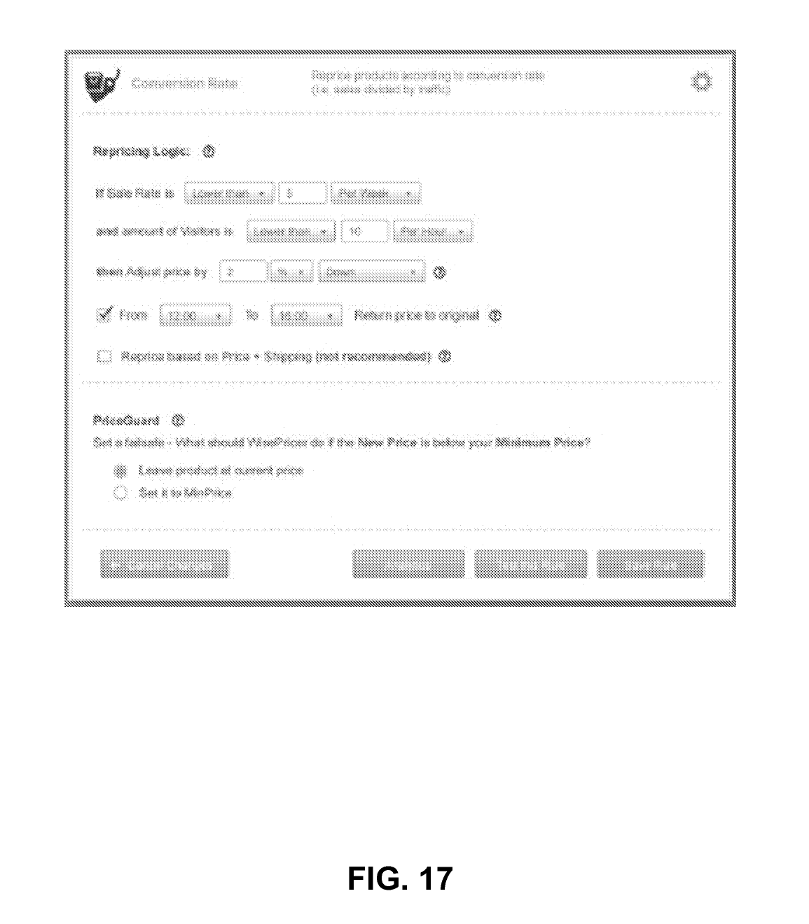

The system may sync with the user's website data to capture conversion rate data to incorporate into a dynamic pricing rule. Conversion rate is similar to traffic in that it indicates clearly when a product is not priced optimally. If there is high traffic and low sales, something is wrong. In this case, the price is usually too high. Conversely, items that get a high traffic with a high conversion rate can be marked up due to their inherent popularity. Once the rules are set, the system enables automated pricing based on those rules. For example, FIG. 17 shows a user interface for configuring a pricing rule based on conversion rate. In contrast to site traffic, which is a measure of the number of views a particular web page receives, conversions represent more significant events, such as a consumer adding a product to his shopping cart or the consumer completing the purchase. Using a pricing rule configuration interface, like the interface illustrated by FIG. 17, the seller can reprice products according to a conversion rate within a configurable time period (e.g., hour, day, week, month, etc.) and the number of visitors within a separately configurable time period. The seller may further configure the pricing rule to adjust the price by a specified fixed amount or a specified percentage amount up or down. If the specified lower or higher conversion rate occurs during the specified time period, the system will apply the pricing rule to automatically adjust the price of the products upwards or downwards according to the specified price adjustment. In some embodiments, the traffic-based pricing rule may be further configured to ignore traffic-based price adjustments during certain time periods. Like other pricing strategies, the seller can also set a minimum price below which the product cannot be repriced.

Price According to Sales Velocity.

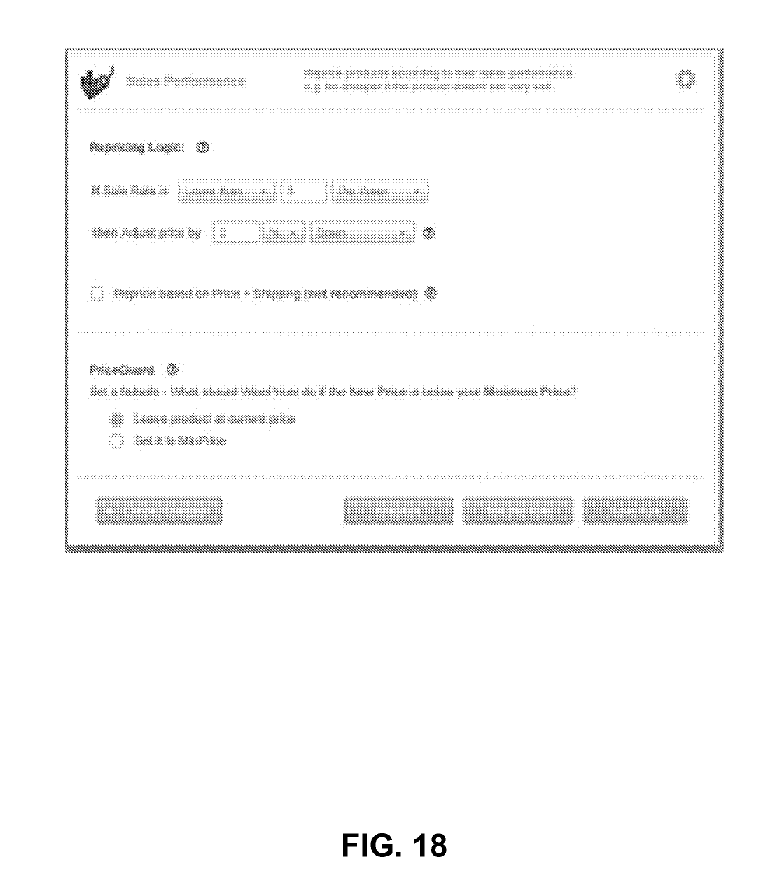

The system enables the user to set pricing rules based on sales velocity. In this circumstance, the price is based on how well the item is sold. For example, if the user wants to sell 10 units per week of a given product, the conversion rate goal would follow as 10 sales per week. To reach this goal, the user can adjust pricing rules according to the competition, time, traffic and conversion rate. The system enables A/B testing of pricing strategies; the user can fluctuate the price and experiment with the strategies until they get to the designated sales target. For example, FIG. 18 shows a user interface for configuring a pricing rule based on sales velocity. Using such an interface, the seller can reprice products according to a sales rate within a configurable time period (e.g., hour, day, week, month, etc.). The seller may further configure the pricing rule to adjust the price by a specified fixed amount or a specified percentage amount up or down in response to the specified change in sale rate. Like other pricing strategies, the seller can also set a minimum price below which the product cannot be repriced.

Price Elasticity Finder Utilizing Dynamic Pricing.

In some embodiments, the system may enable the user to determine price elasticity through dynamic pricing. In this circumstance, the price is based on how the market actually performs per given merchant store. If the price elasticity experiment is set, then the system connects to the sales history data and identifies the product demand level along with volatility rates, standard deviation, and more. The system will then suggest a certain price point to experiment and will update the price on a daily basis, or other desired time interval. Once the price is set, the system tracks and monitors the sales data and to allow the user to see how the following metrics are responding: sales, profit, and revenue. The system will then show the change in these metrics and will constantly change price according to the sales, demand, and ST (standard deviation) levels to set the highest profit level.

### Dynamic Pricing Algorithms

Determining optimal selling prices from sales data is a challenging task. It requires a method that is both capable of learning consumer behavior from sales data, and optimizing the profit (or revenue). Since consumer behavior may be changing over time, it should also be capable of handling fluctuating market environments. This application describes such a dynamic pricing and learning method.

Consider a seller who can charge different selling prices for a product in different time periods, and who is interested in learning the optimal selling price. This optimal selling price is estimated from historical sales data, and continuously updated each time new sales data becomes available. The estimates are only based on recent sales data; this is because consumer behavior and market characteristics may change over time, which makes older sales data less informative.

This application presents a method of dynamic pricing and learning algorithm. Ideally, the firm always charges the price that is optimal according to statistical estimates based on recent sales data. The statistical estimates are not always reliable enough, in which case one can employ a pricing strategy aimed at increasing the price dispersion. The idea behind this is that the quality of the estimated optimal price (i.e. the statistical estimation error) is affected by the amount of price dispersion in the sales data: the higher the price dispersion, the better the estimate of the optimal price. This means that price variation may cost money in the short term (because it means that sub-optimal selling prices are used) but saves money in the long term (because it improves estimates of future optimal prices).

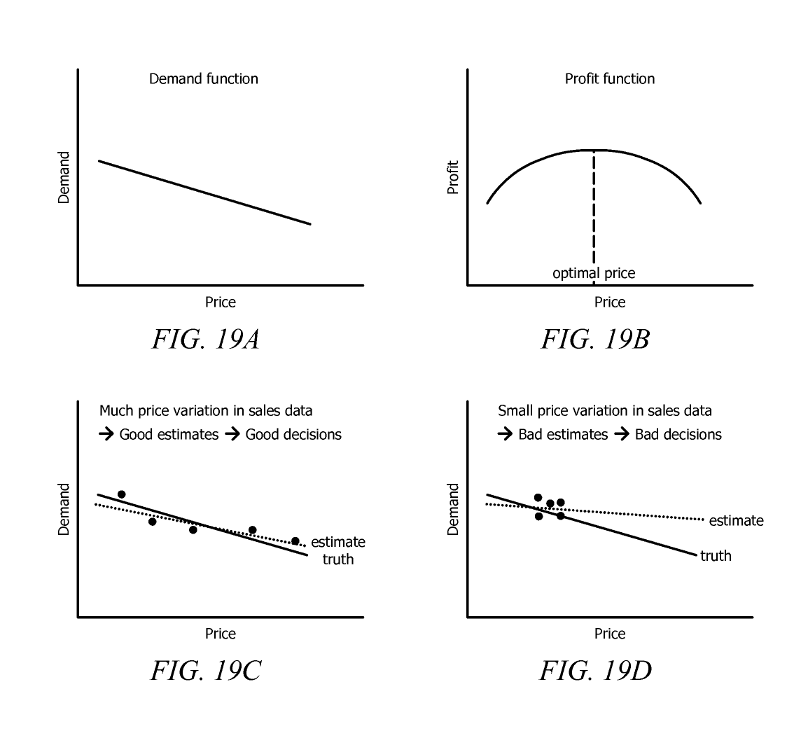

To illustrate, FIG. 19C shows an estimated demand function based on a series of sales data. Each data point represents the number of units sold within a particular time period at a particular price. A least means squared linear regression may applied to find the best fit line, thus defining the estimated demand function. The true demand curve has been drawn to illustrate estimation error from the linear regression. FIG. 19D illustrates the problem with low price dispersion. Tightly clustered data points lead to wildly inaccurate estimation of the demand curve (as illustrated by contrasting slopes of the estimate line and the truth line).

The dynamic pricing algorithm disclosed herein balances between these two aspects of price variation.

Consider dynamic pricing for a single product. If multiple products are sold, it may be beneficial to use a pricing algorithm that estimates substitution effects from sales data, and jointly determines the selling prices for all products. Methods capable of this do exist, but are much more involved than the method described in this application.

The time horizon is divided in discrete time periods. A single time period may correspond to a week, a day, five minutes, et cetera, depending on the choice of the seller. Each time period the seller may change the selling price of the product. For the purposes of the model, it is assumed that the product does not get sold out during a time period. This is not a strong assumption if the time periods are relatively short. If a product gets out-of-stock during a time period, the sales does not equal the demand in that period. Estimation procedures for such censored observations exist, but are beyond the scope of this document.

The number of products sold per time period is called the demand. The expected (or average) demand in a single time period, as function of selling price p, is assumed to be of the form

D(p)=a−bp

We adopt a linear demand model, which is the most commonly used demand model in marketing and economics. It is easy to use, implement, and estimate. A potential disadvantage is that it is only a valid model in the price range where a−b*p is positive (since demand cannot be negative). Alternative demand models that do not have this drawback are the exponential demand model D(p)=e^{a-bP}, or the logit demand model

$$D ( p ) = \frac{const}{1 + {e}^{- a + bp}} .$$

These models can be used as well in the pricing algorithm.

Here a and b are unknown positive parameters that describe the market. The profit per single time period, as function of p, equals

(p−c)(a−bp)

where c is the unit cost price of the product. The price that maximizes expected profit per time period, denoted by p*, equals

$${p}^{*} = \frac{a}{2 b} + \frac{c}{2}$$

The value of p* is unknown to the seller: it depends on the unknown parameters a and b that describe the market. Its value can be learned, however, by estimating it from sales data.

FIG. 19A shows a graph of demand as a function of price. In an elastic market, the graph illustrates the well-understood economic principle that lower prices increased demand for a product and higher prices decrease demand for the product. FIG. 19B shows a graph of profit as a function of price. FIG. 19B predicts that an optimal price may be reached in the middle of a range of possible prices. As price decreases, demand increases. As demand increases, sales increase, which lift profits to a point. However, at a certain inflection point (optimal price point), profits will begin to fall off with continued decreases in price because margins are squeezed (i.e., unit cost decreases more slowly than the corresponding demand curve increases as function of sales volume).

The sales data after n time periods consists of price-demand pairs (p(i),d(i)), for all time periods i=1, . . . , n, where p(i) denotes the selling price used in period i, and d(i) the observed demand in period i.

In each time period, the algorithm estimates the unknown parameters a and b based on historical sales data. A measure of the quality of fit is used to determine whether the fit is good or not. If the fit is good, we use it to subsequently estimates the optimal price, and uses this estimated optimal price in the next time period. If the fit is not good, we employ a deterministic strategy to vary the prices in a certain range of prices, in an effort to measure more price points, and increase the chances of a good demand curve fit in the future. After observing the demand generated by this new selling price, the estimates of a and b and the estimated optimal price are recalculated using sales data that includes the most recent observation. The new estimated optimal price is then used in the subsequent period, and so on.

The algorithm estimates the a and b with least-squares linear regression, based on the N most recent sales data points. The reason not to use all available sales data is that consumer behavior is not fixed but may change over time. In the demand model this means that the parameters a and b may change over time. Because old sales data is less informative if changes in the market have occurred, we only use recent sales data. The value of N is not fixed—we iterate over an increasing value of N. At each step we estimate the a and b parameters, and calculate the fit quality metric. If the fit is good enough, we accept the a and b values. If the fit is not good, N is increased, and we repeat the process until some Nₘₐₓ value is reached. It is possible to choose Nₘₐₓ equal to infinity; this simply means that all available sales data is used. (This is only reasonable under very stable market conditions). If sales data from less than N time periods is available, we use all available sales data.

Furthermore we assume that the seller has a lowest and highest admissible price that are acceptable. These are denoted by pₘᵢₙ and pₘₐₓ. The algorithm is provided as follows:

In periods 1, 2:
1. Choose admissible initial prices p(1), p(2), not equal to each other.

At the beginning of each period n≧3:
2. Estimate a and b with least-squares linear regression based on the N most recent data points (pₙ₁, dₙ₁), (pₙ₂ dₙ₂), . . . , (p_{nN}, d_{nN}). Let âₙ, \hat{b}ₙ denote these estimates.
3. Calculate the quality of fit metric Q(âₙ, \hat{b}ₙ) (this can be the R² metric for instance). If it is below the quality threshold, increase N to N+, and repeat stage 2. If the quality metric is above the threshold, continue to step 4
4. Choose optimal pₙ based on chosen utility function. This can be profit, revenue, or a balance between the two.

Large N means that much data is taken into account to estimate the demand function: this gives more accurate estimates in a stationary market, but it also means slower response to changes in the market. A small value of N is more responsive to changes in the market, but takes fewer data points into account and thus gives less accurate estimates in a stable market situation.

The algorithm updates the estimated parameters whenever new sales data becomes available, which results in a new estimated optimal price for the next time period.

The utility function may vary according to the business goals. Often, a portfolio approach is desired, rather than an independent strategy for each product. For instance, we may want to price some products for optimal profit, but others at discounted prices, in order to grow market share. An appropriate utility function is one that interpolates between profit, and revenue:

U=(p−λ*c)(a−bp)

Here is between 0 and 1. When λ=0, the utility function is revenue. When λ=1, the utility function is profit. A typical strategy can be that products with high average demand are priced to optimal profit, while low average demand products, need to increase market share, and are optimized to discounted price, by optimizing U with a value λ<1. The free parameter λ can be determined, by adding additional constraints, for instance that the total operating margin be in a certain narrow range. One can then try a number of values for λ, searching for a value for which the total operating margin reaches the desired range.

### Analytics

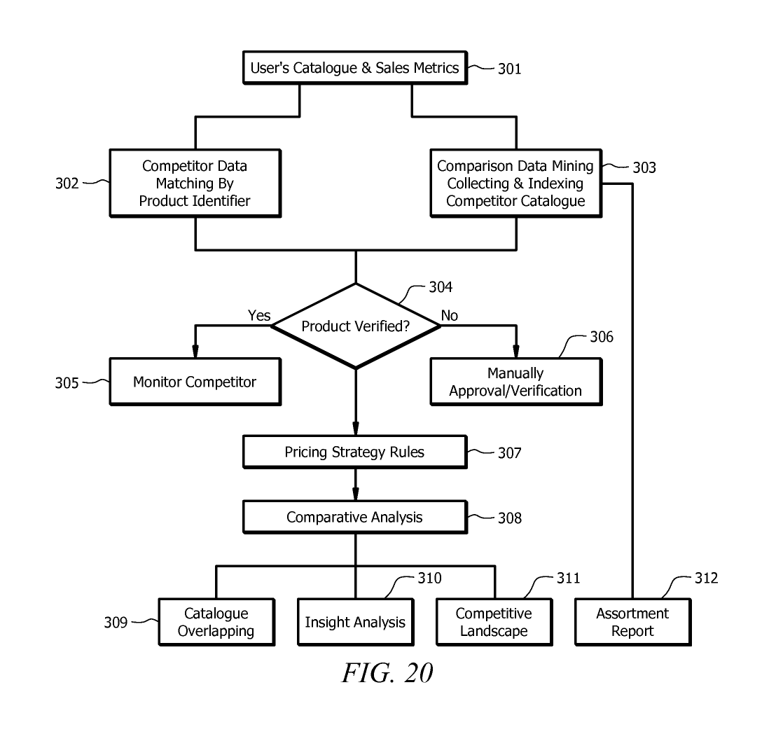

FIG. 20 illustrates the platform the user can utilize to monitor the progress of sales of each different product. The analytics method is suited for the user to analyze which of their products is being priced effectively. First, system collects of the user's data 301. Next, the product identifier is used to match the competitor's products 302, or the product can be matched by making a comparison to the competitor's indexed catalogue 303. In one embodiment, a user is given the option to select between steps 302 and 303. In an alternate embodiment, one of the particular steps is implemented depending upon the available data. In yet another embodiment, both steps may be implemented contemporaneously. The results of the matched products realized in step 303 are displayed in the assortment report 312. The results realized from step 302 are displayed in the catalogue overlapping 309, insight analysis 310, and competitive landscape 311.

In a different embodiment, a near real-time system analyzes the results of each aforementioned user-set pricing rule based on sales, revenue, and profit. The user can then decide whether to change the pricing rule, assign to certain group of SKUs, or leave the current pricing rule. The results of each rule set by the user are measured and reported on the dashboard daily or near real-time, depending on the frequency of feed updating, which is set during the implementation.

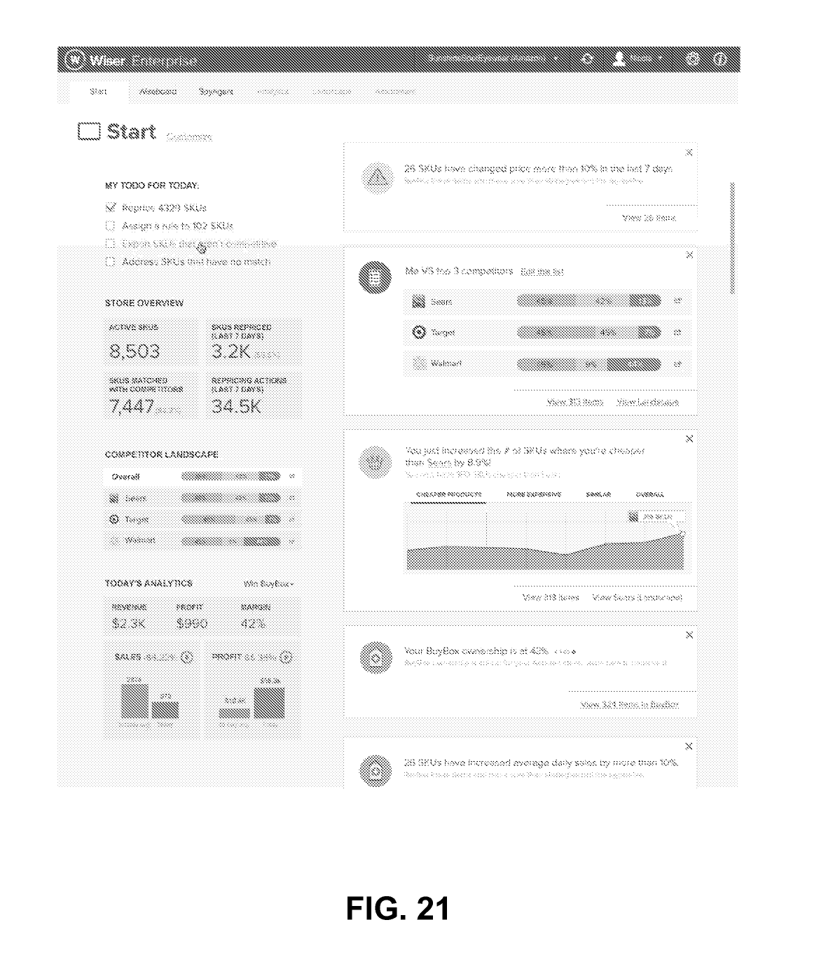

FIG. 21 illustrates a configurable dashboard 2100 that presents a high-level summary of the seller's sales metrics, including a store overview, a mini-view of the competitor landscape, and various analytics. The primary purpose of the dashboard 2100 is to display configurable notifications that alert the seller when certain pricing events occur. For example, notification types might include, pending actions, Amazon alerts, data alerts, SKU alerts, competitive landscape alerts, brand alerts, and product category alerts. With respect to certain alerts that relate to configurable groups of products, the system may permit the seller to customize what competitors can trigger such alerts. Notifications may be delivered simultaneously across multiple client types or delivery formats, including: web application alerts, in-app notifications, push notifications, email, text, instant message, etc. For email alerts, the system can select from different frequency options, including: daily, weekly, or monthly.

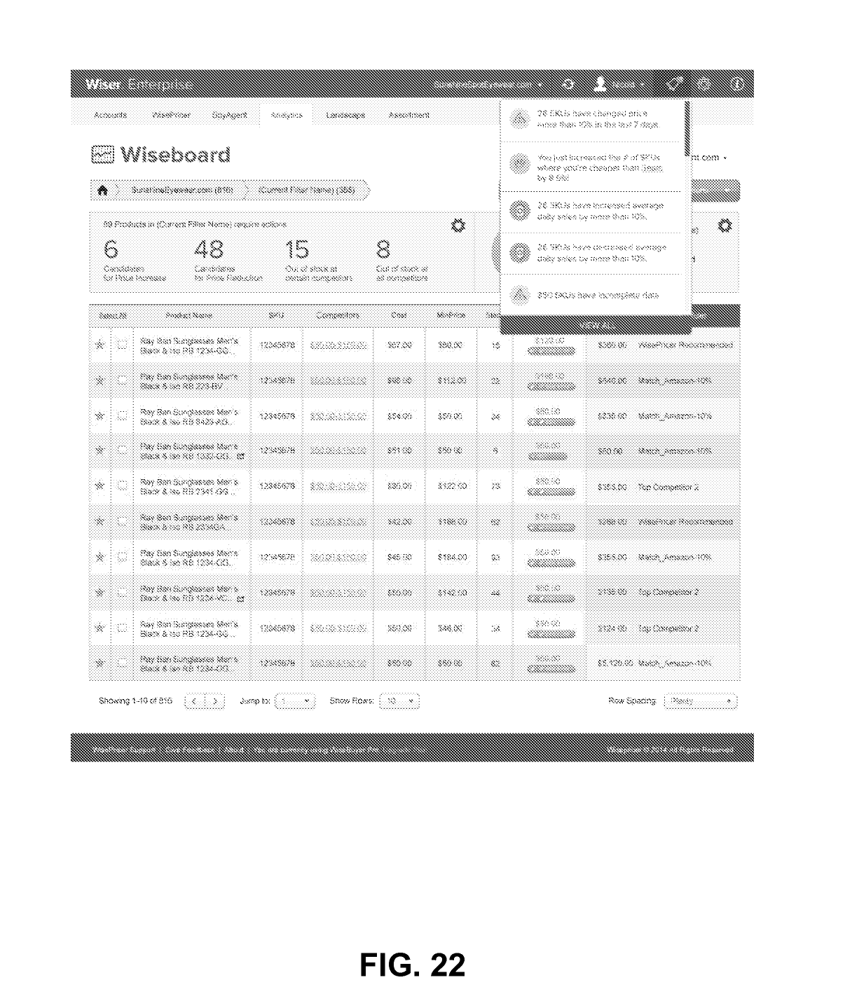

FIG. 22 illustrates a user interface that provides a more detailed grid view of the seller's product catalogue. In this non-limiting example, the products are presented in a list form along with preselected information. Each product in the list may be presented with relevant product information including but not limited to a product SKU, cost, price range, etc.

Summarizing information may also be presented to provide a snapshot view of the selected items.

### Price and Performance Trends

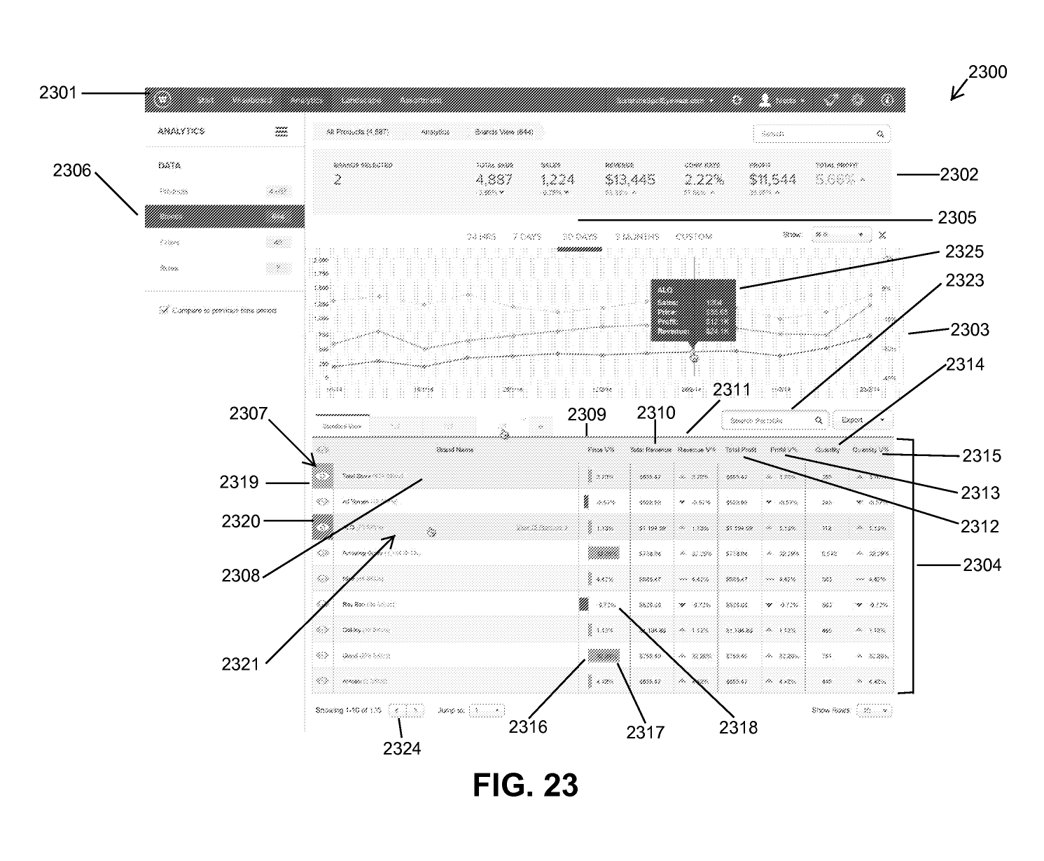

FIG. 23 illustrates a user interface 2301 from the WisePricer Analytics module 2300. WisePricer Analytics is an online data visualization tool to help sellers evaluate whether or not their repricing strategies are producing desirable results (e.g., increased profit or sales), and to help them find spots where they can optimize their pricing strategies even more. The tool provides high level reporting on sales and profit performance and shows data from all channels (web store, eBay, Amazon, etc.). The webtool 2300 must accurately display revenue, quantity, profit, margin %, and conversion rates by each cut of the data (rules, category, labels, etc).

The key purpose of the WisePricer Analytics module 2300 is to provide pricing analysts a quick and easy way to monitor progress on their repricing campaigns without having to do the analysis themselves. As illustrated by FIG. 23, this user interface 2301 should be detailed and interactive enough to save analysts from having to perform similar analyses in spreadsheet programs such as MS Excel® and yet well-organized enough to present sales performance reports to senior management.

The interface 2301 is comprised of several sub-views, including: a summary bar 2302, performance history graph 2303, a performance comparison table 2304, a timer period picker 2305, and a data source picker 2306. FIG. 23 illustrates one arrangement of the sub-views; however, other layouts are also possible.

The performance summary table 2304 shows a grid of performance metrics by each cut of the data (rule, category, label, etc). For example, the first row 2307, which is labeled “Total Store,” shows the sales metrics for the brand “Total Store.” The table 2304 also comprises data shown in columns, which includes: data cut name 2308, price variance (%) 2309, total revenue 2310, revenue variance (%) 2311, total profit 2312, total profit variance (%) 2313, quantity 2314, and quantity variance (%) 2315. In addition to the text contained in each cell, other visualization techniques may be used, such as a colored horizontal bar 2316, the width of which indicates the magnitude of change, and where the color and direction of travel with respect to an arbitrary vertical axis which indicates a positive or negative change. For example, the price change of 32.29% shown in cell 2317 might be visualized using a green bar to the right of a reference axis. In comparison, the price change of −9.72% in cell 2318 might be visualized using a shorter red bar that extends to the left of the referenced axis. Other visualization techniques might include colored arrows that indicate positive or negative change. Such a technique might even include a third state, such as a horizontal yellow bar when no significant change, within a specified threshold, has been recorded.

Clicking on any of the column headings allows the user to toggle sorting options on the data grid view 2304. When the seller clicks on a particular row for to select it, the user interface 2301 may alter the background color of the row. Additionally, when the user selects a row from the table 2304, a selection indicator 2319, 2320 is displayed using an assigned color, which corresponds to the trend lines in the performance history graph 2303. For example, the first indicator icon 2319 may be assigned the color orange, and the second indicator icon 2320 may be assigned the color green. Any color may be assigned; however it is advisable to select from a list of colors that are easily contrastable.

FIG. 23 shows the first row 2307 and the third row 2321 selected. When the user selects a row, a message is sent to the graph view 2303, which loads the data points for the selected data cut and renders it as a trend line on the graph. Likewise, summary sales performance metrics for all of the selected rows are shown in the summary bar 2302.

Summary bar 2302 shows high level summary of the data (the number of data categories selected, the total SKUs present in the selection, the number of products sold, the total revenue, conversion rate, profit, and total profit). The summary bar 2302 also shows the change in each sales metric for the selected data categories as compared to the previous time period. It should be noted that if the user selects more than row, the system will display aggregated metrics for the union of the underlying data set. For example, if the user selects categories that have overlapping SKUs, the overlapping portion will not be double-counted.

Performance history graph 2303 shows trend lines for each of the selected rows that are colored to match the corresponding selection indicators 2319, 2320. The graph shows the currently selected performance metric (e.g. profit variance) over time plotted against price trend. When the user hovers over a particular trend line, an additional popup view 2325 is displayed that shows additional performance metrics, such as sales, price, profit, and revenue for the nearest data point. The user interface 2301 may allow the user to select other performance metrics to graph for the selected data categories. If the graph becomes too crowded, the user has the option if toggling certain trend lines on or off using the trend line picker 2322.

The time period picker 2305 enables the seller to evaluate changes in sales, profit, and quantity across time (weekly, monthly, custom).

The data grid 2304 also provides a search field 2323 to help the user quickly find particular rows, and pagination controls 2324 to facilitate navigation of data sets that are too large to show on one page.

FIG. 23 illustrates the sales performance of different brands within the seller's catalog. However, data cut selector 2306 enables the seller to select other ways of comparing sales data, such as by product, by competition rule, or by custom filter. For example, the user could use the cut selector 2306 to instead compare performance of different rules (pricing campaigns) across time, or compare performance of different product categories across time.

In alternate embodiments, the user interface 2301 may show also show several types of advanced pricing analytics such as elasticity reporting, or permit the user to create custom dashboards.

### Competitive Landscape

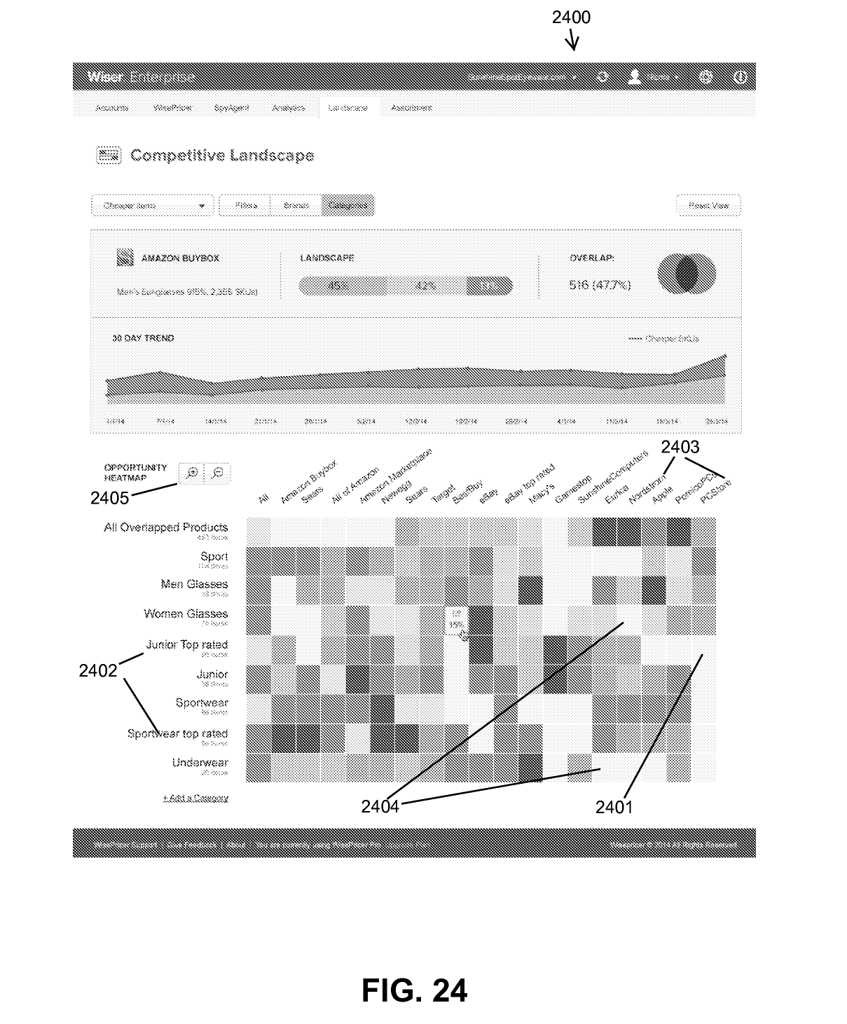

FIG. 24 illustrates the Competitive Landscape user interface 2400, which shows a zoomable heatmap 2401 of the seller's product categories versus configured competitors. The list of product categories 2402 are listed vertically to the left of the heatmap 2401. The competitors 2403 associated with the seller's account are listed in a row across the top of the heatmap 2401. Any given cell 2404 within the heatmap 2401 represents the seller's competitiveness for the product category associated with the cell's row versus the competitor associated with the cell's column. If the current zoom level 2405 of the heatmap does not permit the competitive index (a ratio of the seller's prices over the competitor's prices) to be printed within the cell, the competitive index may instead by viewed by hovering the mouse pointer over the cell 2404 in the grid. In addition to the printed competitive index, each cell may be colored according to a red/green gradient pattern, where the more red a cell is the less competitive the seller is, and where the more green the cell is the more competitive the seller is. If the user zooms in, less rows and columns will be displayed in the heatmap 2401 but each cell will appear larger. Conversely, if the user zooms out, more rows and columns of the heatmap 2401 will be displayed on the Competitive Landscape user interface 2400.

### WiseMapper

In a different embodiment the sellers are able to monitor their products' pricing across thousands of online retailers. This method is designed for brands to manage their distribution channels. If the user's brand is producing essential products that are in-turn sold through a number of e-Commerce channels through this embodiment the seller is able to be 100% positive that the distribution channels aren't dramatically distorting the pricing of their products in a way that is deleterious to their brand. For example: if the user is selling through XYZ Website they want to make sure that they aren't charging rates that dramatically undercut their MSRP. If they do, WiseMapper can actually take a screenshot so that the seller have undeniable proof.

This embodiment sends data mining algorithms to the resellers' website such as Google Shopping, Amazon, eBay and monitors the reselling network. The system monitors the prices the resellers are setting for the sellers' products and alerts the user if the product is being sold for a price below the minimum advertising price (MAP). The user can chose to receive email reports every time a product is being sold below the MAP price. The user also has the option of automatically sending the reseller an email warning them they are violating the sellers' minimum price and should stop. The user also has the option of sending a second email if the reseller does not cease to price below the minimum authorized price. The user may choose to export the report of how their product has been priced as a CVS spreadsheet or monitor and document the violations on the Wiseboard.

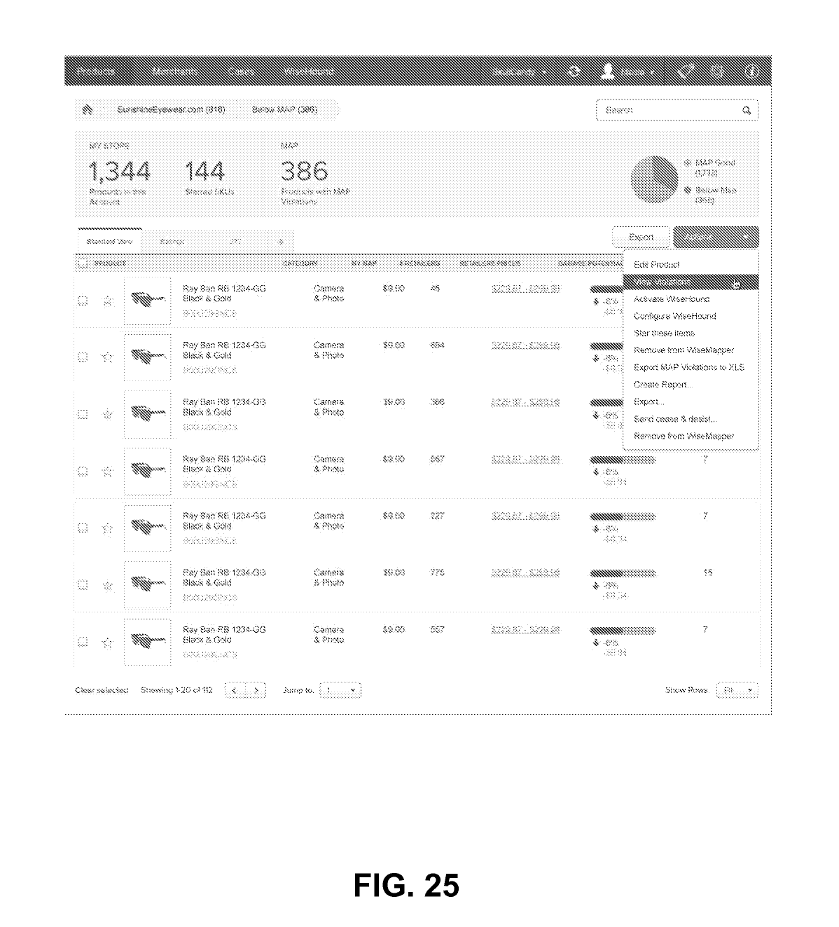

FIG. 25 exemplifies a way that the user is able to monitor if their product is priced below the MAP (Minimum Advertised Price). Manufactures use MAP to protect brand image, maintain retail value, and keep margins ideal for resellers. On the left upper corner of the WiseBoard, the user gets a report of products that needs action. The first alert is whether their products are being sold below the MAP price. When the user point and click on the number above the “Products Below Map” the system takes the user to a different page where the system shows exactly which products are in violation and who is violating the minimum advertising price. The user can chose to contact the violator directly or the system can automatically contact the violator with a warning.

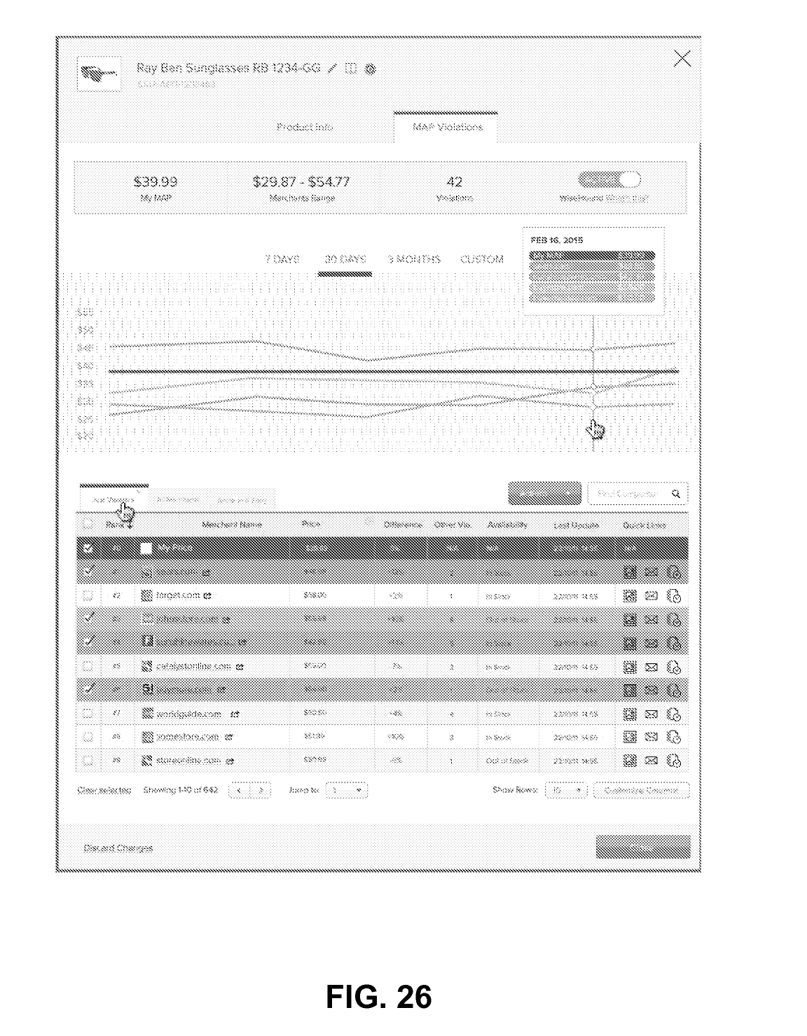

FIG. 26 is another user interface for monitoring minimum advertised pricing violators. The competitor list view displays the resellers, the price they are setting for the merchant's products and the difference between the MAP. If the price is set below MAP, the Difference will be shown in red and the percentage on the right.

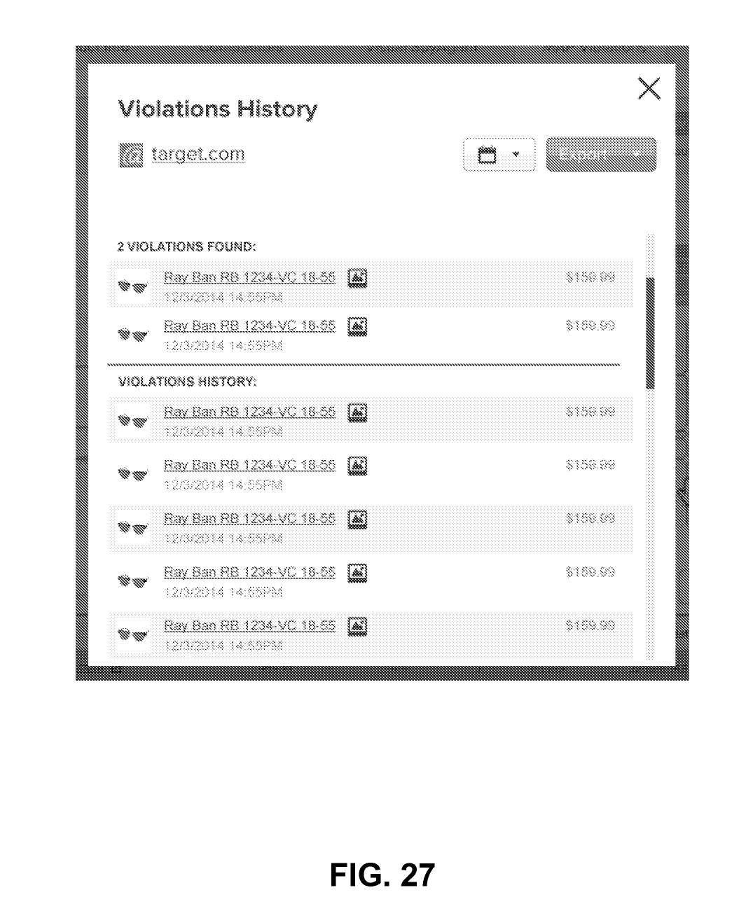

FIG. 27 depicts a user interface for monitoring a MAP violators in accordance with an illustrative embodiment. After the user contacts the violators or has the system automatically contact the violators to change their prices, the user is able to monitor whether the violators have changed the prices or are still violating by monitoring the alerts, having automatic emails sent and/or use the SpyAgent to keep track of any past or future violation over a period amount of time.

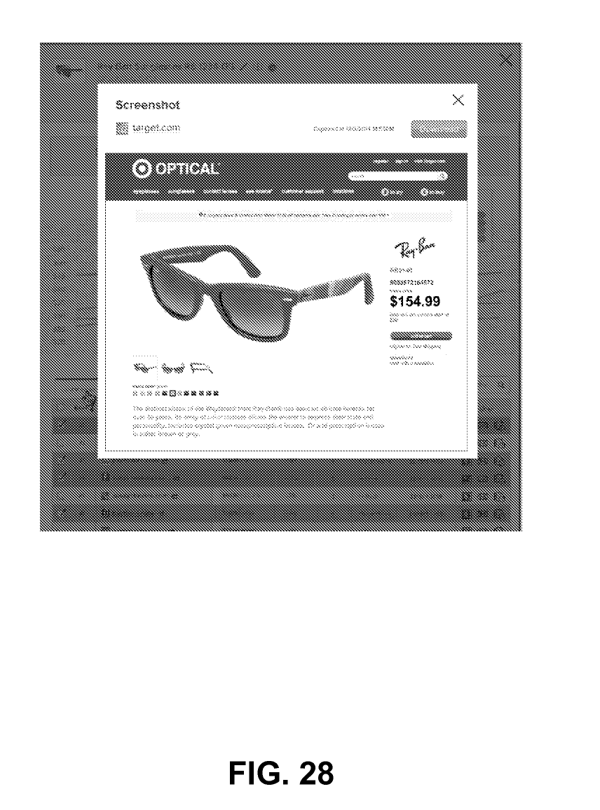

FIG. 28 illustrates a user interface for reviewing screen shot evidence of a MAP violation. When Wise scrapers visit a competitor's web store, the scraper may be configured to take a “screenshot” by rendering an image of the product page visited using a CSS-compliant layout engine. The screenshot may then be uploaded to the system via the Cloud. Alternatively, the scraper may merely log the URL of the page containing the MAP violation so that another system service may later capture the screenshot. However, the longer the delay between the scraper's traversal of the page and when the screenshot is captured, the greater the likelihood of a price change occurring between the two capture points.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural, materials, and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

We claim:

1. A method of automating price changes for a webstore, comprising the steps:
(a) defining a product that is sold via a first webstore;
(b) identifying a second webstore that competes with the first webstore;
(c) configuring a scraper based on a layout of the second webstore;
(d) determining whether the product is offered for sale through the second webstore by instructing the scraper to scrape data from a webpage of the second webstore;
(e) if the scraper finds an exact product match on the webpage, storing attributes of the exact product match in a data store;
(f) creating a price data point from the stored attributes;
(g) compiling pricing data for the product by repeating steps (d) through (f) over a time period; and
(h) estimating an optimal price for the product by applying a user-specified pricing rule to the pricing data.

2. The method of claim 1, further comprising:
transmitting to the first webstore a file containing the estimated optimal price for the product.

3. The method of claim 1, further comprising:
providing an embeddable script that may be incorporated into a product page of the first web store, wherein the product page offers the product for sale;
receiving a sale notification message from a remote system executing the embeddable script, which was triggered by a customer completing a purchase of the product from the first webstore;
extracting from the sale notification message data attributes associated with the product transaction; and
creating a sales data point based on the data attributes and inserting the sales data point into a sales data repository.

4. The method of claim 3, further comprising:
estimating an optimal price for the product by applying a user-specified pricing rule to a set of sales data in the sales data repository.

5. The method of claim 1, wherein the user-specified pricing comprises a dynamic pricing algorithm.

6. The method of claim 1, wherein the user-specified pricing rule is configured to price the product below the cheapest competitor.

7. The method of claim 1, wherein the user-specified pricing rule is configured to set the price to the average across all competitors.

8. The method of claim 1, wherein the user-specified pricing rule is configured to set the price based on the most expensive competitor.

9. The method of claim 1, wherein the user-specified pricing rule is based on a markup percentage over the cost of the product.

10. The method of claim 1, further comprising:
receiving from a remote system a pixel request triggered by a browser on the remote system running the web beacon script, which was downloaded from a product page associated with the first webstore.

11. The method of claim 1, wherein the scraper is further configured to use fuzzy matching if the scraper does not find an exact product match on the webpage.

12. The method of claim 1, wherein the scraper is further configured to estimate a unit price for the exact product match based on a specified unit of measurement.

13. The method of claim 1, wherein the scraper is further configured to throttle itself in response to the second store blocking the scraper.

14. The method of claim 1, further comprising:
presenting sales performance metrics through a data analytics interface, wherein the sales performance metrics may be filtered and manipulated using the data analytics interface;
selecting a second pricing rule based on an indication that the pricing rule is not producing optimal results.

15. A web-based pricing system, comprising:
a product user interface hosted via a web server, wherein the product user interface enables a user to define a product that is sold via a first webstore;
a competitor user interface hosted via the web server, wherein the competitor user interface enables a user to identify a second webstore that competes with the first webstore;
a parallel-processing cluster configured to execute one or more instances of a scraper, wherein the scraper is configured to navigate a layout of the second webstore;
a first instance of the scraper from the one or more instances of the scraper executing on the parallel-processing cluster, wherein the first instance:
i. determines whether the product is offered for sale through the second webstore by instructing the scraper to scrape data from a webpage of the second webstore;
ii. if the first instance finds an exact product match on the webpage, the first instance stores attributes of the exact product match in a data store connected to the web-based pricing system;
iii. creates a price data point from the stored attributes; and
a batch processing component connected to the data store, wherein the batch processing component compiles pricing data for the product over a time period, and wherein the batch processing component estimates an optimal price for the product by applying a user-specified pricing rule to the pricing data.

16. The web-based pricing system of claim 15, further comprising:
a pricing automation component, wherein the pricing automation component transmits to the first webstore a file containing the estimated optimal price for the product.

17. The web-based pricing system of claim 15, further comprising:
a data analytics component, connected to the web server, wherein the data analytics component provides sales data aggregated from web visits and product sales on the first web store.
